(19) United States
(12) Patent Application Publication
(10) Pub. No.: US 2014/0362258 A1
(43) Pub. Date: Dec. 11, 2014

(54) IMAGE PROCESSING APPARATUS, IMAGE PROCESSING METHOD, AND COMPUTER READABLE RECORDING MEDIUM

(71) Applicants: Olympus Corporation, Tokyo (JP); Olympus Imaging Corp., Tokyo (JP)

(72) Inventors: Manabu ICHIKAWA, Tokyo (JP); Atsushi ISHIHARA, Tokyo (JP); Manabu KATO, Sagamihara-shi (JP); Yoshihisa NISHIYAMA, Tokyo (JP)

(21) Appl. No.: 14/298,311

(22) Filed: Jun. 6, 2014

(30) Foreign Application Priority Data
Jun. 10, 2013 (JP) 2013-121912

(51) Int. Cl. H04N 5/262

(52) U.S. Cl. CPC H04N 5/2628; H04N 5/2621
USPC 348/240.1; 348/239

(57) ABSTRACT

An image processing apparatus includes a special image processing unit. The special image processing unit includes an image resize unit that performs a resize process of resizing an image size of at least a partial area of an image area of image data by using one position in at least the partial area as a center, and an image composition unit that performs a composition process of compositing the image data and image data obtained through the resize process such that the respective one positions coincide with each other.

### CROSS-REFERENCE TO RELATED APPLICATIONS

This application is based upon and claims the benefit of priority from Japanese Patent Application No. 2013-121912, filed on Jun. 10, 2013, the entire contents of which are incorporated herein by reference.

### BACKGROUND OF THE INVENTION

1. Field of the Invention

The present invention relates to an image processing apparatus, an image processing method, and a computer readable recording medium for performing image processing on image data.

2. Description of the Related Art

Conventionally, as an image shooting technique using a camera (imaging apparatus), so-called zoom blur photography is known, in which the position of a zoom lens (hereinafter, described as a zoom position) is changed during exposure.

In such zoom blur photography, a range to be captured is changed, so that an image radiating out from the center is captured and a unique aesthetic effect (hereinafter, a zoom effect) is applied to the captured image.

Furthermore, as an imaging apparatus for performing such zoom blur photography, a technique has been proposed to perform the zoom blur photography by electrically changing the zoom position during an exposure time calculated by an automatic exposure process (see, for example, Japanese Laid-open Patent Publication No. 2011-13333).

### SUMMARY OF THE INVENTION

In accordance with some embodiments, an image processing apparatus, an image processing method by the image processing apparatus and a computer readable recording medium are presented.

In some embodiments, an image processing apparatus includes a special image processing unit. The special image processing unit includes: an image resize unit that performs a resize process of resizing an image size of at least a partial area of an image area of image data by using one position in at least the partial area as a center; and an image composition unit that performs a composition process of compositing the image data and image data obtained through the resize process such that the respective one positions coincide with each other.

In some embodiments, an image processing method executed by an image processing apparatus is presented. The image processing method includes: resizing an image size of at least a partial area of an image area of image data by using one position in at least the partial area as a center; and compositing the image data and image data obtained at the resizing such that the respective one positions coincide with each other.

In some embodiments, a non-transitory computer readable recording medium with an executable program stored thereon is presented. The program instructs a processor provided in an image processing apparatus to execute: resizing an image size of at least a partial area of an image area of image data by using on position in at least the partial area as a center; and compositing the image data and image data obtained at the resizing such that the respective one positions coincide with each other.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of a user-facing side of an imaging apparatus according to a first embodiment of the present invention;

FIG. 2 is a block diagram illustrating a configuration of the imaging apparatus according to the first embodiment of the present invention;

FIG. 3 is a flowchart illustrating operation of the imaging apparatus according to the first embodiment of the present invention;

FIG. 4 is a diagram illustrating screen transition of a menu screen displayed on a display unit when a menu switch according to the first embodiment of the present invention is operated;

FIG. 5 is a flowchart illustrating an outline of shooting by a mechanical shutter according to the first embodiment of the present invention;

FIG. 6 is a flowchart illustrating an outline of a rec view display process according to the first embodiment of the present invention;

FIG. 7 is a diagram for explaining a special image processing step according to the first embodiment of the present invention;

FIG. 8 is a diagram illustrating a coefficient multiplied by a signal of each pixel of second finish effect image data in each of repeatedly performed composition processes according to the first embodiment of the present invention;

FIG. 9 is a diagram illustrating an example of a rec view image displayed on the display unit by a display controller according to the first embodiment of the present invention;

FIG. 10 is a flowchart illustrating an outline of a live view display process according to the first embodiment of the present invention;

FIG. 11 is a diagram illustrating an example of a live view image displayed on the display unit by the display controller according to the first embodiment of the present invention;

FIG. 12 is a diagram illustrating a change in a coefficient in each of repeatedly performed composition processes according to a first modified example of the first embodiment of the present invention;

FIG. 13 is a diagram for explaining a special image processing step according to a second modified example of the first embodiment of the present invention;

FIG. 14 is a flowchart illustrating an outline of a live view display process according to a second embodiment of the present invention;

FIG. 15 is a diagram for explaining a special image processing step according to the second embodiment of the present invention;

FIG. 16 is a flowchart illustrating an outline of shooting by a mechanical shutter according to a third embodiment of the present invention;

FIG. 17 is a flowchart illustrating an outline of a rec view display process according to a fourth embodiment of the present invention;

FIG. 18 is a flowchart illustrating an outline of a live view display process according to the fourth embodiment of the present invention;

FIG. 19 is a block diagram illustrating a configuration of an imaging apparatus according to a fifth embodiment of the present invention;

FIG. 20 is a flowchart illustrating an outline of shooting by a mechanical shutter according to the fifth embodiment of the present invention;

FIG. 21 is a flowchart illustrating an outline of a rec view display process according to the fifth embodiment of the present invention;

FIG. 22 is a diagram for explaining a special image processing step according to the fifth embodiment of the present invention;

FIG. 23 is a diagram illustrating a coefficient multiplied by a signal of each pixel of resize process image data in a composition process according to the fifth embodiment of the present invention;

FIG. 24 is a flowchart illustrating an outline of a live view display process according to the fifth embodiment of the present invention;

FIG. 25 is a diagram illustrating a part of screen transition of a menu screen displayed on a display unit when a menu switch according to a sixth embodiment of the present invention is operated;

FIG. 26 is a diagram for explaining a resize process according to the sixth embodiment;

FIG. 27 is a diagram illustrating a part of screen transition of a menu screen displayed on a display unit when a menu switch according to a seventh embodiment of the present invention is operated; and

FIG. 28 is a diagram for explaining a special image processing step according to the seventh embodiment.

### DETAILED DESCRIPTION OF THE PREFERRED EMBODIMENTS

Exemplary embodiments (hereinafter, embodiments) of the present invention will be explained below with reference to the accompanying drawings. The present invention is not limited to the embodiments explained below. Furthermore, the same components are denoted by the same reference numerals in the drawings.

### First Embodiment

### Overall Configuration of Imaging Apparatus

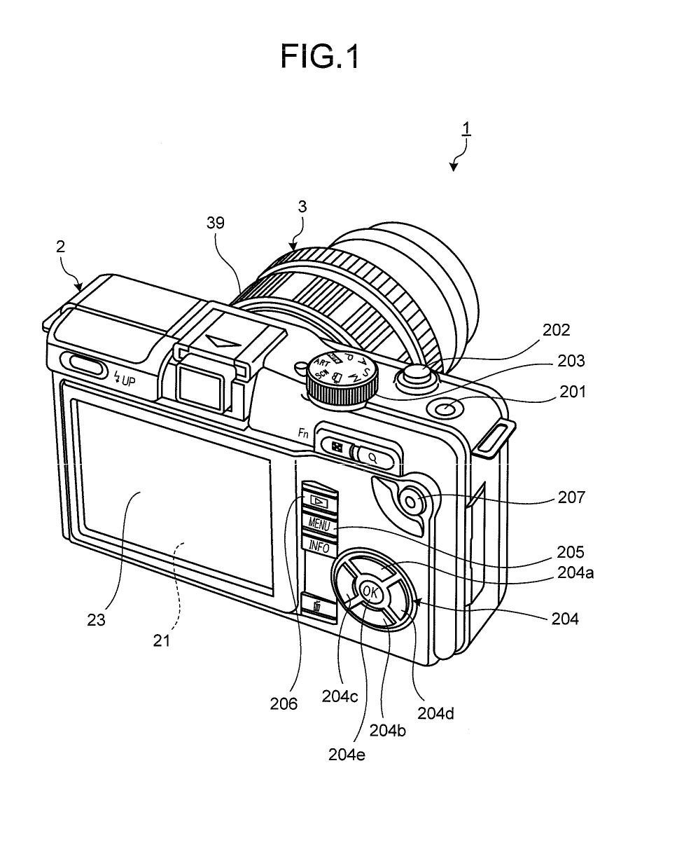

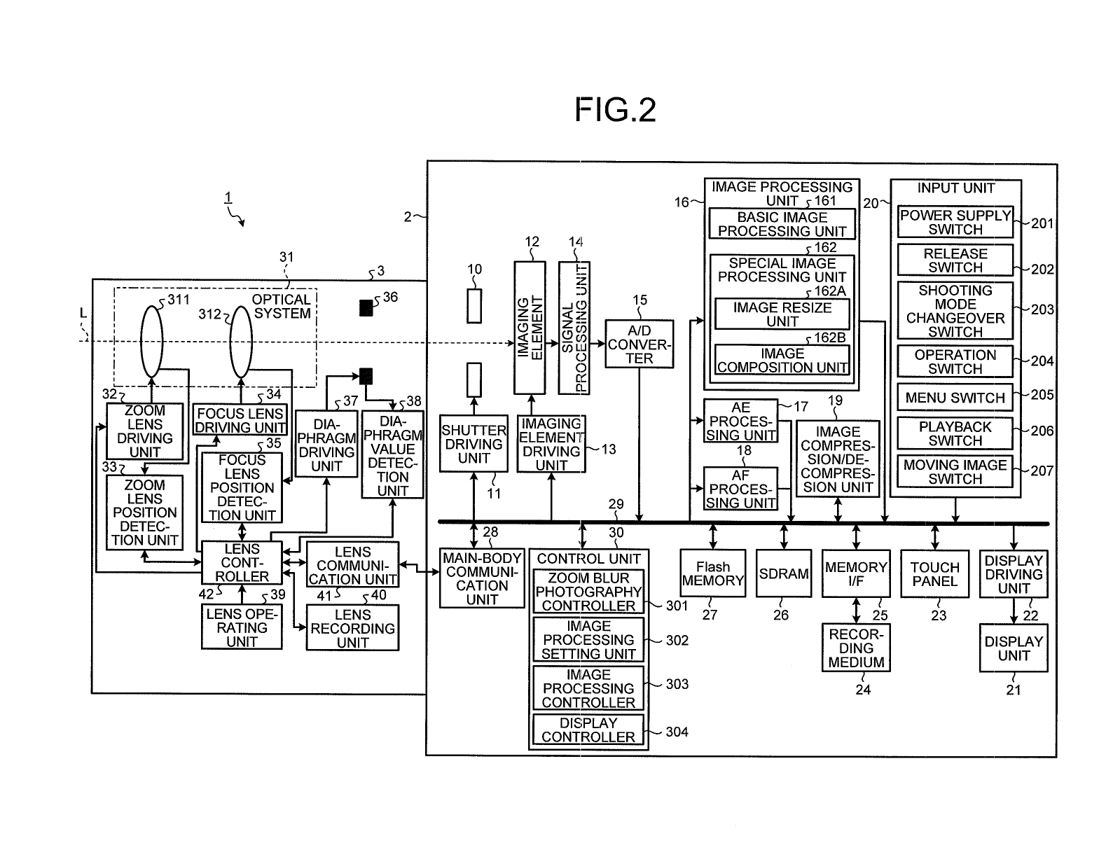

FIG. 1 is a perspective view illustrating a configuration of a user facing side (front side) of an imaging apparatus according to a first embodiment of the present invention. FIG. 2 is a block diagram illustrating a configuration of the imaging apparatus.

An imaging apparatus 1 includes, as illustrated in FIG. 1 and FIG. 2, a main body 2 and a lens unit 3 detachably attached to the main body 2.

### Configuration of Main Body

The main body 2 includes, as illustrated in FIG. 2, a shutter 10, a shutter driving unit 11, an imaging element 12, an imaging element driving unit 13, a signal processing unit 14, an A/D converter 15, an image processing unit 16, an AE processing unit 17, an AF processing unit 18, an image compression/decompression unit 19, an input unit 20, a display unit 21, a display driving unit 22, a touch panel 23, a recording medium 24, a memory I/F 25, an SDRAM (Synchronous Dynamic Random Access Memory) 26, a flash memory 27, a main-body communication unit 28, a bus 29, a control unit 30, and the like.

The shutter 10 sets a state of the imaging element 12 to an exposed state or a light-blocked state.

The shutter driving unit 11 is configured by using a stepping motor or the like, and drives the shutter 10 according to an instruction signal input from the control unit 30.

The imaging element 12 is configured by using a CCD (Charge Coupled Device), a CMOS (Complementary Metal Oxide Semiconductor), or the like that receives light collected by the lens unit 3 and converts the light to an electrical signal.

The imaging element driving unit 13 outputs image data (analog signal) from the imaging element 12 to the signal processing unit 14 at a predetermined timing according to an instruction signal input from the control unit 30. In this sense, the imaging element driving unit 13 functions as an electronic shutter.

The signal processing unit 14 performs analog processing on the analog signal input from the imaging element 12, and outputs the processed signal to the A/D converter 15.

Specifically, the signal processing unit 14 performs a noise reduction process, a gain-up process, or the like on the analog signal. For example, the signal processing unit 14 reduces reset noise or the like from the analog signal, performs waveform shaping, and performs gain-up to obtain desired brightness.

The A/D converter 15 performs A/D conversion on the analog signal input from the signal processing unit 14 to generate digital image data, and outputs the digital image data to the SDRAM 26 via the bus 29.

The image processing unit 16 is a section that functions as an image processing apparatus according to the present invention and is configured to acquire image data from the SDRAM 26 via the bus 29 and perform various types of image processing on the acquired image data (RAW data) under control of the control unit 30. The image data subjected to the image processing is output to the SDRAM 26 via the bus 29.

The image processing unit 16 includes, as illustrated in FIG. 2, a basic image processing unit 161 and a special image processing unit 162.

The basic image processing unit 161 performs, on image data, at least basic image processing including an optical black subtraction process, a white balance adjustment process, an image data synchronization process when an imaging element has a Bayer array, a color matrix calculation process, a gamma correction process, a color reproduction process, an edge enhancement process, and the like. Furthermore, the basic image processing unit 161 performs a finish effect process to reproduce a natural image based on a preset parameter of each image processing. The parameter of each image processing is a contrast value, a sharpness value, a saturation value, a white balance value, or a tone value.

For example, processing items of the finish effect process include “Natural” as a processing item to finish a captured image in natural colors, “Vivid” as a processing item to finish a captured image in vivid colors, “Flat” as a processing item to finish a captured image by taking into account material texture of a captured object, “Monotone” as a processing item to finish a captured image in monochrome tone, and the like.

The special image processing unit 162 performs a special effect process to produce a visual effect by combining multiple types of image processing on image data. The combination for the special effect process is, for example, a combination including at least one of a tone curve process, a blurring process, a shading addition process, a noise superimposition process, a saturation adjustment process, a resize process, and a composition process.

For example, processing items of the special effect process include “pop art”, “fantastic focus”, “toy photo”, “diorama”, “rough monochrome”, and “zoom blur photography (simulation)”.

The special effect process corresponding to the processing item “pop art” is a process to enhance colors in a colorful manner to express a bright and joyful atmosphere. The image processing for “pop art” is realized by a combination of, for example, the saturation adjustment process, a contrast enhancement process, and the like.

The special effect process corresponding to the processing item “fantastic focus” is a process to express an ethereal atmosphere with a soft tone to produce a beautiful image with fantasy-like style as if a subject is surrounded by the light of happiness while retaining details of the subject. The image processing for “fantastic focus” is realized by a combination of, for example, the tone curve process, the blurring process, an alpha blending process, the composition process, and the like.

The special effect process corresponding to the processing item “toy photo” is a process to express an old time or nostalgia by applying a shading effect to the periphery of an image. The image processing for “toy photo” is realized by a combination of, for example, a low-pass filter process, a white balance process, a contrast process, a shading process, a hue/saturation process, and the like.

The special effect process corresponding to the processing item “diorama” is a process to express a toy-like or an artificial looking by applying a strong blurring effect to the periphery of an image. The image processing for “diorama” is realized by a combination of, for example, the hue/saturation process, the contrast process, the blurring process, the composition process, and the like (see, for example, Japanese Laid-open Patent Publication No. 2010-74244 for details of toy photo and shading).

The special effect process corresponding to the processing item “rough monochrome” is a process to express a gritty looking by adding strong contrast and film-grain noise. The image processing for “rough monochrome” is realized by a combination of, for example, the edge enhancement process, a level correction optimization process, a noise pattern superimposition process, the composition process, the contrast process, and the like (see, for example, Japanese Laid-open Patent Publication No. 2010-62836 for details of rough monochrome).

The special effect process corresponding to the processing item “zoom blur photography (simulation)” is a process to simulate a zoom effect to be obtained by zoom blur photography. The image processing for “zoom blur photography (simulation)” is realized by a combination of the resize process and the composition process.

In FIG. 2, only an image resize unit 162A and an image composition unit 162B that implement the image processing for “zoom blur photography (simulation)” that is a main feature of the present invention are illustrated as functions of the special image processing unit 162.

The image resize unit 162A performs a resize process of enlarging an image size of a partial area of an image area of image data by using one position in the partial area as a center.

The image composition unit 162B performs a composition process of compositing image data that is not subjected to the resize process and image data obtained through the resize process such that the respective one positions coincide with each other.

The special image processing unit 162 performs an iterative process of repeating the resize process and the composition process a predetermined number of times.

In the iterative process, the resize process is re-performed on image data obtained through a previous composition process, and image data that is not subjected to the resize process and image data obtained through the re-performed resize process are composited by the composition process such that the respective one positions coincide with each other.

The AE processing unit 17 acquires image data stored in the SDRAM 26 via the bus 29, and sets an exposure condition for performing still image shooting or moving image shooting based on the acquired image data.

Specifically, the AE processing unit 17 calculates luminance from the image data, and determines, for example, a diaphragm value, an exposure time, an ISO sensitivity, or the like based on the calculated luminance to perform automatic exposure (Auto Exposure) of the imaging apparatus 1.

Namely, the AE processing unit 17 functions as an exposure time calculation unit according to the present invention.

The AF processing unit 18 acquires image data stored in the SDRAM 26 via the bus 29, and adjusts autofocus of the imaging apparatus 1 based on the acquired image data. For example, the AF processing unit 18 extracts a signal of a high-frequency component from the image data, performs an AF (Auto Focus) calculation process on the signal of the high-frequency component to determine focusing evaluation of the imaging apparatus 1, and adjusts the autofocus of the imaging apparatus 1.

As a method of adjusting the autofocus of the imaging apparatus 1, it may be possible to employ a method of acquiring a phase difference signal by an imaging element or a method of providing a dedicated AF optical system.

The image compression/decompression unit 19 acquires image data from the SDRAM 26 via the bus 29, compresses the acquired image data according to a predetermined format, and outputs the compressed image data to the SDRAM 26. A still image compression method is a JPEG (Joint Photographic Experts Group) method, a TIFF (Tagged Image File Format) method, or the like. Furthermore, a moving image compression method is a Motion JPEG method, an MP4 (H.264) method, or the like. Moreover, the image compression/decompression unit 19 acquires image data (compressed image data) recorded in the recording medium 24 via the bus 29 and the memory I/F 25, expands (decompresses) the acquired image data, and outputs the expanded image data to the SDRAM 26.

The input unit 20 includes, as illustrated in FIG. 1, a power supply switch 201 that switches a power supply state of the imaging apparatus 1 to an on-state or an off-state; a release switch 202 that receives input of a still image release signal to give an instruction on still image shooting; a shooting mode changeover switch 203 that switches between various shooting modes (a still image shooting mode, a moving image shooting mode, and the like) set in the imaging apparatus 1; an operation switch 204 that switches between various settings of the imaging apparatus 1; a menu switch 205 that displays, on the display unit 21, various settings of the imaging apparatus 1; a playback switch 206 that displays, on the display unit 21, an image corresponding to the image data recorded in the recording medium 24; a moving image switch 207 that receives input of a moving image release signal to give an instruction on moving image shooting; and the like.

The release switch 202 is able to move back and forth in response to external pressure, receives input of a first release signal designating shooting preparation operation when being pressed halfway, and receives input of a second release signal designating still image shooting when being fully pressed.

The operation switch 204 includes upward, downward, leftward, and rightward directional switches 204a to 204d to perform selection and setting on the menu screen or the like, and a confirmation switch 204e (OK switch) to confirm operation by the directional switches 204a to 204d on the menu screen or the like (FIG. 1). The operation switch 204 may be configured by using a dial switch or the like.

The display unit 21 is configured by using a display panel made of liquid crystal, organic EL (Electro Luminescence), or the like.

The display driving unit 22 acquires, under control of the control unit 30, image data stored in the SDRAM 26 or image data recorded in the recording medium 24 via the bus 29, and displays an image corresponding to the acquired image data on the display unit 21.

Display of an image includes a rec view display to display image data for a predetermined time immediately after shooting, a playback display to playback image data recorded in the recording medium 24, a live view display to sequentially display live view images corresponding to pieces of image data sequentially generated by the imaging element 12 in chronological order, and the like.

Furthermore, the display unit 21 appropriately displays information on operation or shooting by the imaging apparatus 1.

The touch panel 23 is, as illustrated in FIG. 1, provided on a display screen of the display unit 21, detects touch of an external object, and outputs a position signal corresponding to the detected touch position.

In general, a resistive touch panel, a capacitive touch panel, an optical touch panel, and the like are known as a touch panel. In the first embodiment, any type of touch panel may be employed as the touch panel 23.

The recording medium 24 is configured by using a memory card or the like to be attached from outside the imaging apparatus 1, and is detachably attached to the imaging apparatus 1 via the memory I/F 25.

In the recording medium 24, the image data subjected to a process by the image processing unit 16 or the image compression/decompression unit 19 is written by a corresponding type of read/write device (not illustrated). Or, the read/write device reads out image data recorded in the recording medium 24. Furthermore, the recording medium 24 may output programs or various types of information to the flash memory 27 via the memory I/F 25 and the bus 29 under control of the control unit 30.

The SDRAM 26 is configured by using a volatile memory, and temporarily stores therein image data input from the A/D converter 15 via the bus 29, image data input from the image processing unit 16, and information being processed by the imaging apparatus 1.

For example, the SDRAM 26 temporarily stores therein pieces of image data sequentially output for each frame by the imaging element 12 via the signal processing unit 14, the A/D converter 15, and the bus 29.

The flash memory 27 is configured by using a nonvolatile memory.

The flash memory 27 records therein various programs (including an image processing program) for operating the imaging apparatus 1, various types of data used during execution of the programs, various parameters needed for execution of the image processing by the image processing unit 16, or the like.

For example, the various types of data used during execution of the programs include a display frame rate to display a live view image on the display unit 21 (for example, 60 fps in the case of the still image shooting mode and 30 fps in the case of the moving image shooting mode).

The main-body communication unit 28 is a communication interface for communicating with the lens unit 3 mounted on the main body 2.

The bus 29 is configured by using a transmission path or the like that connects the components of the imaging apparatus 1, and transfers various types of data generated inside the imaging apparatus 1 to each of the components of the imaging apparatus 1.

The control unit 30 is configured by using a CPU (Central Processing Unit) or the like, and integrally controls operation of the imaging apparatus 1 by, for example, transferring corresponding instructions or data to each of the components of the imaging apparatus 1 in accordance with the instruction signal or the release signal from the input unit 20 or the position signal from the touch panel 23 via the bus 29. For example, when the second release signal is input, the control unit 30 causes the imaging apparatus 1 to start shooting operation. The shooting operation by the imaging apparatus 1 indicates operation to cause the signal processing unit 14, the A/D converter 15, and the image processing unit 16 to perform predetermined processes on image data output by the imaging element 12 by driving the shutter driving unit 11 and the imaging element driving unit 13. The image data processed as described above is compressed by the image compression/decompression unit 19 and recorded in the recording medium 24 via the bus 29 and the memory I/F 25 under control of the control unit 30.

The control unit 30 includes, as illustrated in FIG. 2, a zoom blur photography controller 301, an image processing setting unit 302, an image processing controller 303, a display controller 304, and the like.

The zoom blur photography controller 301 outputs instruction signals to the shutter driving unit 11, the imaging element driving unit 13, and the lens unit 3 in accordance with the instruction signal from the input unit 20 or the position signal from the touch panel 23, each of which is input via the bus 29, and performs shooting while moving a zoom lens 311 (zoom blur photography) as will be described later.

The image processing setting unit 302 sets contents of image processing (a finish effect process or a special effect process) to be performed by the image processing unit 16 in accordance with the instruction signal from the input unit 20, the position signal from the touch panel 23, and the like input via the bus 29.

The image processing controller 303 causes the image processing unit 16 to perform image processing in accordance with the contents of the image processing set by the image processing setting unit 302.

The display controller 304 controls a display mode of the display unit 21.

The main body 2 configured as described above may be provided with an audio input/output function, a flash function, a removable electronic viewfinder (EVF), a communication unit capable of performing bidirectional communication with external processors such as personal computers via the Internet, or the like.

### Configuration of Lens Unit

The lens unit 3 includes, as illustrated in FIG. 2, an optical system 31, a zoom lens driving unit 32, a zoom lens position detection unit 33, a focus lens driving unit 34, a focus lens position detection unit 35, a diaphragm 36, a diaphragm driving unit 37, a diaphragm value detection unit 38, a lens operating unit 39, a lens recording unit 40, a lens communication unit 41, and a lens controller 42.

The optical system 31 condenses light from a predetermined field area, and focuses the condensed light on an imaging plane of the imaging element 12. The optical system 31 includes, as illustrated in FIG. 2, the zoom lens 311 and a focus lens 312.

The zoom lens 311 is configured by using one or more lenses, and moves along an optical axis L (FIG. 2) to change a zoom factor of the optical system 31.

The focus lens 312 is configured by using one or more lenses, and moves along the optical axis L to change a focal point and a focal distance of the optical system 31.

The zoom lens driving unit 32 is configured by using a stepping motor, a DC motor, or the like, and moves the zoom lens 311 along the optical axis L under control of the lens controller 42.

The zoom lens position detection unit 33 is configured by using a photo interrupter or the like, and detects the position of the zoom lens 311 driven by the zoom lens driving unit 32.

Specifically, the zoom lens position detection unit 33 converts the amount of rotation of a driving motor included in the zoom lens driving unit 32 into the number of pulses, and detects the position of the zoom lens 311 on the optical axis L from a reference position based on the infinity in accordance with the number of pulses obtained by the conversion.

The focus lens driving unit 34 is configured by using a stepping motor, a DC motor, or the like, and moves the focus lens 312 along the optical axis L under control of the lens controller 42.

The focus lens position detection unit 35 is configured by using a photo interrupter or the like, and detects, on the optical axis L, the position of the focus lens 312 driven by the focus lens driving unit 34 in the same manner as employed by the zoom lens position detection unit 33.

The diaphragm 36 adjusts exposure by limiting the incident amount of light condensed by the optical system 31.

The diaphragm driving unit 37 is configured by using a stepping motor or the like, and drives the diaphragm 36 to adjust the amount of light incident on the imaging element 12 under control of the lens controller 42.

The diaphragm value detection unit 38 detects the state of the diaphragm 36 driven by the diaphragm driving unit 37 to detect a diaphragm value of the diaphragm 36. The diaphragm value detection unit 38 is configured by using a potentiometer such as a linear encoder or a variable resistive element, an A/D converter circuit, or the like.

The lens operating unit 39 is, as illustrated in FIG. 1, an operation ring or the like arranged around a lens barrel of the lens unit 3, and receives input of instruction signals to instruct the zoom lens 311 or the focus lens 312 in the optical system 31 to operate or to instruct the imaging apparatus 1 to operate. The lens operating unit 39 may be a push-type switch or the like.

The lens recording unit 40 records therein control programs for determining the positions and operation of the optical system 31 and the diaphragm 36, magnification, a focal distance, an angle of view, aberration, and an F value (brightness) of the optical system 31, or the like.

The lens communication unit 41 is a communication interface for communicating with the main-body communication unit 28 of the main body 2 when the lens unit 3 is mounted on the main body 2.

The lens controller 42 is configured by using a CPU or the like, and controls operation of the lens unit 3 in accordance with an instruction signal or a drive signal input from the control unit 30 via the main-body communication unit 28 and the lens communication unit 41. Furthermore, the lens controller 42 outputs, to the control unit 30, the position of the zoom lens 311 detected by the zoom lens position detection unit 33, the position of the focus lens 312 detected by the focus lens position detection unit 35, and the diaphragm value of the diaphragm 36 detected by the diaphragm value detection unit 38, via the main-body communication unit 28 and the lens communication unit 41.

### Operation of Imaging Apparatus

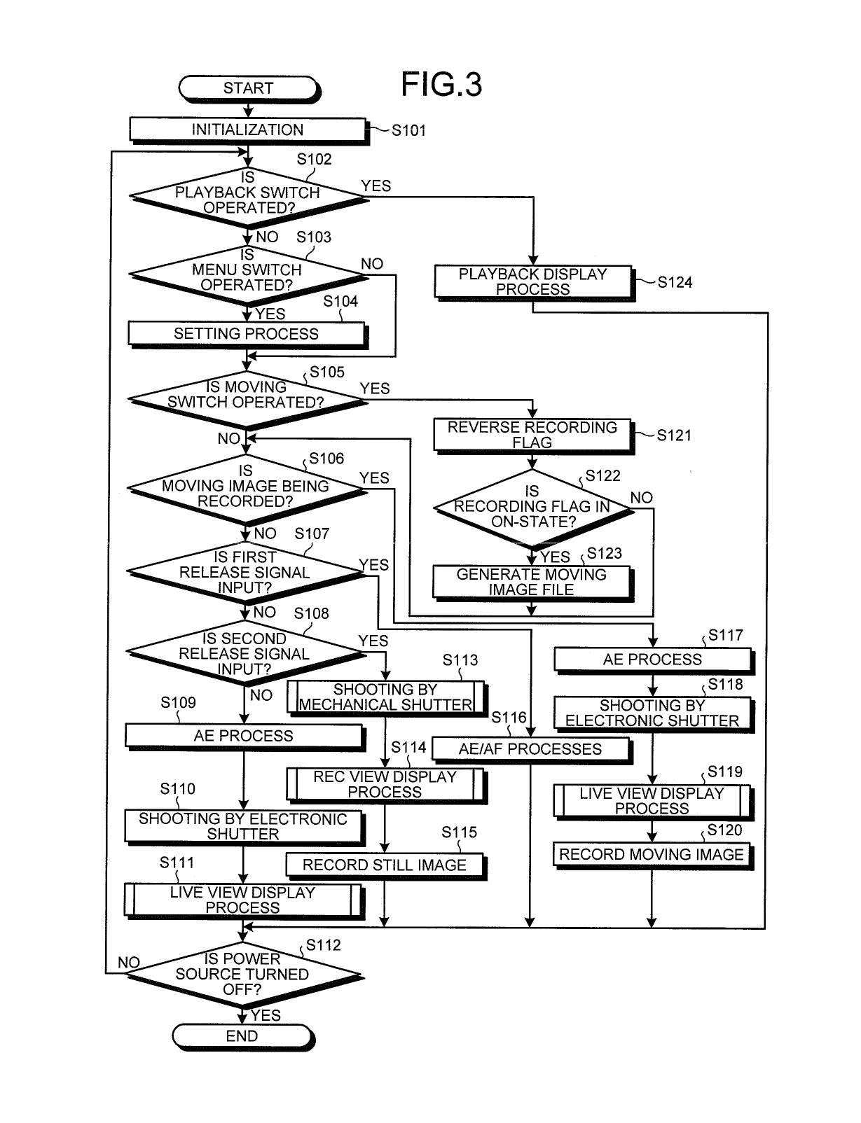

FIG. 3 is a flowchart illustrating operation of the imaging apparatus 1.

When a user operates the power supply switch 201 and a power source of the imaging apparatus 1 is turned on, the control unit 30 initializes the imaging apparatus 1 (Step S101).

Specifically, the control unit 30 performs initialization by setting a recording flag, which indicates a recording state of a moving image, to an off-state. The recording flag is set to an on-state while a moving image is being captured, set to the off-state while a moving image is not being captured, and is stored in the SDRAM 26.

Subsequently, if the playback switch 206 is not operated (Step S102: No), and the menu switch 205 is operated (Step S103: Yes), the imaging apparatus 1 displays a menu operation screen, performs a setting process to set various conditions on the imaging apparatus 1 in accordance with selection operation performed by the user (Step S104), and proceeds to Step S105. Details of the various conditions setting process (Step S104) will be explained later.

In contrast, if the playback switch 206 is not operated (Step S102: No), and the menu switch 205 is not operated (Step S103: No), the imaging apparatus 1 proceeds to Step S105.

Subsequently, the control unit 30 determines whether the moving image switch 207 is operated (Step S105).

When determining that the moving image switch 207 is operated (Step S105: Yes), the imaging apparatus 1 proceeds to Step S121 to be described later.

In contrast, when determining that the moving image switch 207 is not operated (Step S105: No), the imaging apparatus 1 proceeds to Step S106 to be described later.

At Step S106, if the imaging apparatus 1 is not recording a moving image (Step S106: No), and the first release signal is input from the release switch 202 (Step S107: Yes), the imaging apparatus 1 proceeds to Step S116 to be described later.

In contrast, if the first release signal is not input via the release switch 202 (Step S107: No), the imaging apparatus 1 proceeds to Step S108 to be described later.

A case will be explained that the second release signal is not input via the release switch 202 at Step S108, (Step S108: No). In this case, the control unit 30 causes the AE processing unit 17 to perform an AE process of adjusting exposure (Step S109).

Subsequently, the control unit 30 drives the imaging element driving unit 13 to perform shooting by the electronic shutter (Step S110). Image data generated by the imaging element 12 through the shooting by the electronic shutter is output to the SDRAM 26 via the signal processing unit 14, the A/D converter 15, and the bus 29.

Thereafter, the imaging apparatus 1 performs a live view display process of displaying, on the display unit 21, a live view image corresponding to the image data generated by the imaging element 12 through the shooting by the electronic shutter (Step S111). Details of the live view display process (Step S111) will be described later.

Subsequently, the control unit 30 determines whether the power source of the imaging apparatus 1 is turned off by operation of the power supply switch 201 (Step S112).

When determining that the power source of the imaging apparatus 1 is turned off (Step S112: Yes), the imaging apparatus 1 ends the process.

In contrast, when determining that the power source of the imaging apparatus 1 is not turned off (Step S112: No), the imaging apparatus 1 returns to Step S102.

A case will be explained that the second release signal is input from the release switch 202 at Step S108 (Step S108: Yes).

In this case, the control unit 30 performs shooting by a mechanical shutter (Step S113), and performs a rec view display process (Step S114).

Details of the shooting by the mechanical shutter (Step S113) and the rec view display process (Step S114) will be described later.

Furthermore, in the rec view display process (Step S114) in FIG. 3, not only the image processing for the rec view but also image processing for recording are performed, the description is simplified for the convenience sake.

Subsequently, the control unit 30 causes the image compression/decompression unit 19 to compress the image data in the recording format set through the setting process at Step S104, and records the compressed image data in the recording medium 24 (Step S115). Then, the imaging apparatus 1 proceeds to Step S112. Incidentally, the control unit 30 may record, in the recording medium 24, RAW data that has not been subjected to the image processing by the image processing unit 16, in association with the image data compressed in the above described recording format by the image compression/decompression unit 19.

A case will be explained that the first release signal is input from the release switch 202 at Step S107 (Step S107: Yes).

In this case, the control unit 30 causes the AE processing unit 17 to perform the AE process of adjusting exposure and causes the AF processing unit 18 to perform an AF process of adjusting a focus (Step S116). Thereafter, the imaging apparatus 1 proceeds to Step S112.

A case will be explained that the imaging apparatus 1 is recording a moving image at Step S106 (Step S106: Yes).

In this case, the control unit 30 causes the AE processing unit 17 to perform the AE process of adjusting exposure (Step S117).

Subsequently, the control unit 30 drives the imaging element driving unit 13 to perform shooting by the electronic shutter (Step S118). Image data generated by the imaging element 12 through the shooting by the electronic shutter is output to the SDRAM 26 via the signal processing unit 14, the A/D converter 15, and the bus 29.

Thereafter, the imaging apparatus 1 performs the live view display process of displaying, on the display unit 21, a live view image corresponding to the image data generated by the imaging element 12 through the shooting by the electronic shutter (Step S119). Details of the live view display process (Step S119) will be described later.

Subsequently, at Step S120, the control unit 30 causes the image compression/decompression unit 19 to compress the image data in the recording format set by the setting process at Step S104, and records the compressed image data as a moving image in a moving image file generated in the recording medium 24. Incidentally, the compressed image data may be added to a moving image file. Then, the imaging apparatus 1 proceeds to Step S112.

A case will be explained that the moving image switch 207 is operated at Step S105 (Step S105: Yes).

In this case, the control unit 30 reverses the recording flag in the on-state indicating that a moving image is being recorded (Step S121).

Subsequently, the control unit 30 determines whether the recording flag stored in the SDRAM 26 is in the on-state (Step S122).

When determining that the recording flag is in the on-state (Step S122: Yes), the control unit 30 generates a moving image file in the recording medium 24 to record pieces of image data in the recording medium 24 in a chronological order (Step S123), and the imaging apparatus 1 proceeds to Step S106.

In contrast, when determining that the recording flag is not in the on-state (Step S122: No), the imaging apparatus 1 proceeds to Step S106.

A case will be explained that the playback switch 206 is operated at Step S102 (Step S102: Yes).

In this case, the display controller 304 performs a playback display process of acquiring the image data from the recording medium 24 via the bus 29 and the memory I/F 25, decompressing the acquired image data by the image compression/decompression unit 19, and displaying the decompressed image data on the display unit 21 (Step S124). Thereafter, the imaging apparatus 1 proceeds to Step S112. Various Conditions Setting Process

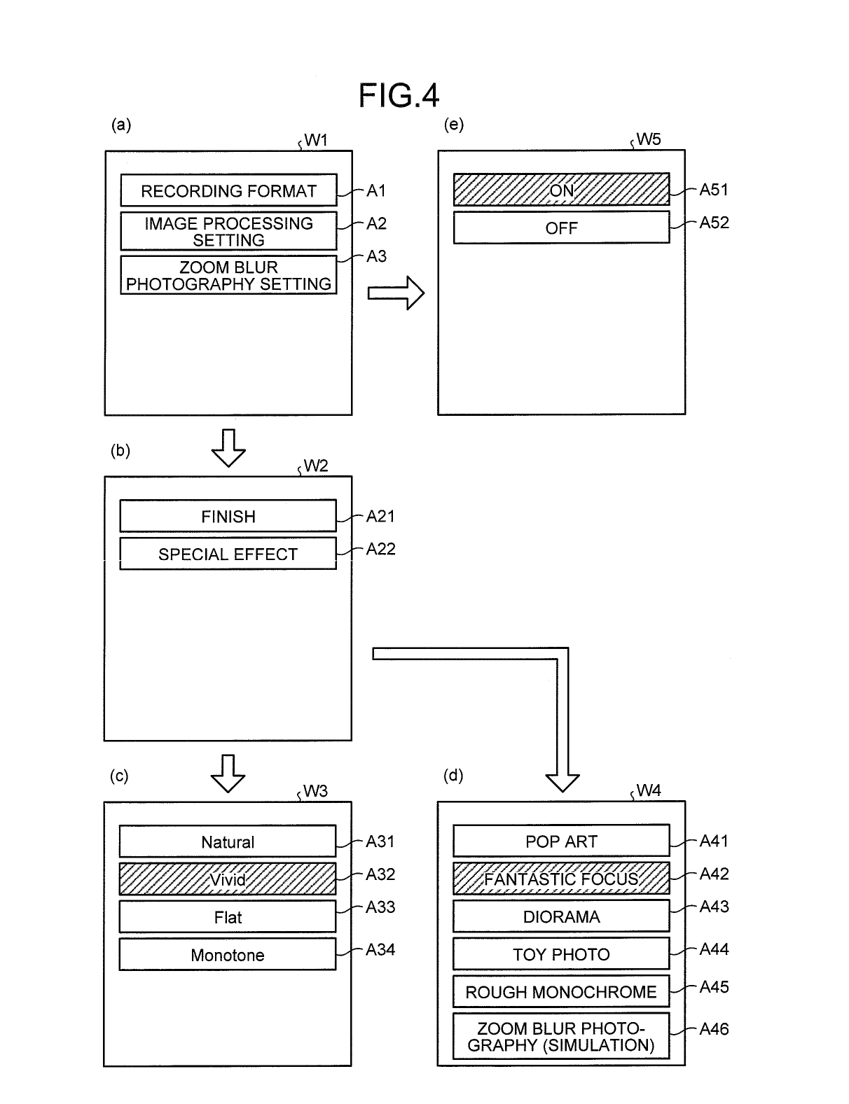

FIG. 4 is a diagram illustrating screen transition of the menu screen displayed on the display unit 21 when the menu switch 205 is operated.

The various conditions setting process (Step S104) illustrated in FIG. 3 will be explained below based on FIG. 4.

When the menu switch 205 is operated, the display controller 304 displays, on the display unit 21, a menu screen W1 with setting contents of the imaging apparatus 1 as illustrated in (a) in FIG. 4.

On the menu screen W1, a recording format icon A1, an image processing setting icon A2, a zoom blur photography setting icon A3, and the like are displayed.

The recording format icon A1 is an icon for receiving input of an instruction signal to display, on the display unit 21, a recording format menu screen (not illustrated) for setting a recording format of each of a still image and a moving image.

The image processing setting icon A2 is an icon for receiving input of an instruction signal to display, on the display unit 21, an image processing selection screen W2 ((b) in FIG. 4).

The zoom blur photography setting icon A3 is an icon for receiving input of an instruction signal to display, on the display unit 21, a zoom blur photography setting screen W5 ((e) in FIG. 4).

If a user touches a display position of the image processing setting icon A2 on the display screen (the touch panel 23) (hereinafter, described as user touch operation) while the menu screen W1 is being displayed on the display unit 21, the image processing setting icon A2 is selected. Then, the display controller 304 displays the image processing selection screen W2 on the display unit 21 as illustrated in (b) in FIG. 4.

On the image processing selection screen W2, a finish icon A21 and a special effect icon A22 are displayed.

The finish icon A21 is an icon for receiving input of an instruction to display, on the display unit 21, a finish effect process selection screen W3 ((c) in FIG. 4) for enabling selection of a finish effect process to be performed by the basic image processing unit 161.

The special effect icon A22 is an icon for receiving input of an instruction signal to display, on the display unit 21, a special effect process selection screen W4 ((d) in FIG. 4) for enabling selection of a special effect process to be performed by the special image processing unit 162.

If the finish icon A21 is selected through the user touch operation while the image processing selection screen W2 is being displayed on the display unit 21, the display controller 304 displays the finish effect process selection screen W3 on the display unit 21 as illustrated in (c) in FIG. 4.

On the finish effect process selection screen W3, as icons corresponding to processing items of the finish effect process, a Natural icon A31, a Vivid icon A32, a Flat icon A33, and a Monotone icon A34 are displayed. Each of the icons A31 to A34 is an icon for receiving input of an instruction signal to designate process settings corresponding to the finish effect process to be performed by the basic image processing unit 161.

If any of the icons A31 to A34 is selected through the user touch operation while the finish effect process selection screen W3 is being displayed on the display unit 21, the display controller 304 displays the selected icon in highlight (indicated by diagonal lines in FIG. 4). In (c) in FIG. 4, a state is illustrated in which the Vivid icon A32 is selected.

Furthermore, the image processing setting unit 302 sets a finish effect process corresponding to the selected icon as a process to be performed by the basic image processing unit 161. Information on the finish effect process set by the image processing setting unit 302 is output to the SDRAM 26 via the bus 29.

Moreover, if the special effect icon A22 is selected through the user touch operation while the image processing selection screen W2 is being displayed on the display unit 21, the display controller 304 displays the special effect process selection screen W4 on the display unit 21 as illustrated in (d) in FIG. 4.

On the special effect process selection screen W4, as icons corresponding to processing items of the special effect process, a pop art icon A41, a fantastic focus icon A42, a diorama icon A43, a toy photo icon A44, a rough monochrome icon A45, and a zoom blur photography (simulation) icon A46 are displayed. Each of the icons A41 to A45 is an icon for receiving input of an instruction signal to designate settings of a special effect process to be performed by the special image processing unit 162. The zoom blur photography (simulation) icon A46 is an icon for receiving input of an instruction signal to designate settings of zoom blur photography (simulation) as a special effect process to be performed by the special image processing unit 162 (an instruction signal for designating a simulation mode to simulate zoom blur photography without moving the zoom lens 311).

Specifically, the touch panel 23 functions as an operation input unit according to the present invention.

If any of the icons A41 to A46 is selected by the user touch operation while the special effect process selection screen W4 is being displayed on the display unit 21, the display controller 304 displays the selected icon in highlight. In (d) in FIG. 4, a state is illustrated in which the fantastic focus icon A42 is selected.

Furthermore, the image processing setting unit 302 sets a special effect process corresponding to the selected icon as a process to be performed by the special image processing unit 162. Information on the special effect process set by the image processing setting unit 302 is output to the SDRAM 26 via the bus 29.

Moreover, if the zoom blur photography setting icon A3 is selected through the user touch operation while the menu screen W1 is being displayed on the display unit 21, the display controller 304 displays the zoom blur photography setting screen W5 on the display unit 21 as illustrated in (e) in FIG. 4.

On the zoom blur photography setting screen W5, an ON icon A51 and an OFF icon A52 are displayed.

The ON icon A51 is an icon for receiving input of an instruction signal to set a zoom blur photography mode in the imaging apparatus 1, and for setting a setting flag of the zoom blur photography mode stored in the SDRAM 26 to an on-state.

The OFF icon A52 is an icon for receiving input of an instruction signal to refrain from setting the zoom blur photography mode in the imaging apparatus 1, and for setting the setting flag of the zoom blur photography mode to an off-state.

If one of the icons A51 and A52 is selected through the user touch operation while the zoom blur photography setting screen W5 is being displayed on the display unit 21, the display controller 304 displays the selected icon in highlight. In (e) in FIG. 4, a state is illustrated in which the ON icon A51 is selected.

Furthermore, the control unit 30 sets the setting flag of the zoom blur photography mode to the on-state when the ON icon A51 is selected, and sets the setting flag of the zoom blur photography mode to the off-state when the OFF icon A52 is selected.

While a case has been explained that the various conditions on the imaging apparatus 1 are set through the user touch operation using the touch panel 23, it may be possible to set the various conditions in the same manner by causing the user to operate the operation switch 204. Shooting by Mechanical Shutter

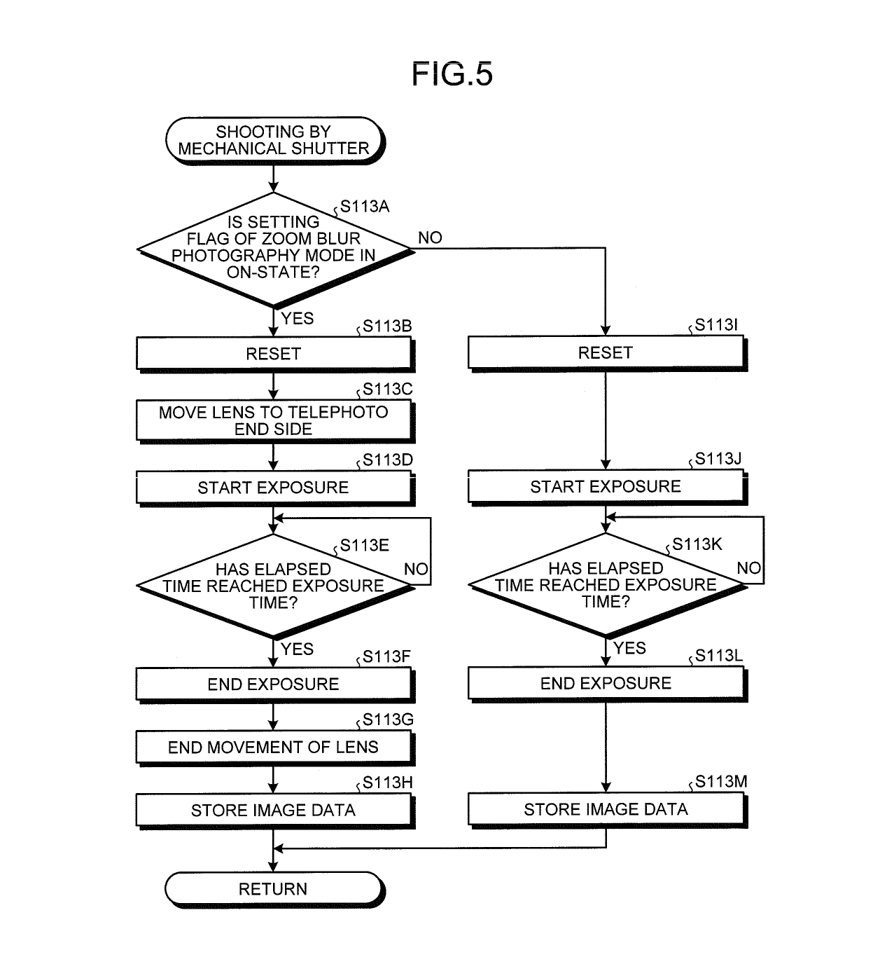

FIG. 5 is a flowchart illustrating an outline of the shooting by the mechanical shutter.

The shooting by the mechanical shutter (Step S113) illustrated in FIG. 3 will be explained below based on FIG. 5.

The control unit 30 determines whether the setting flag of the zoom blur photography mode stored in the SDRAM 26 is in the on-state (Step S113A).

When determining that the setting flag of the zoom blur photography mode is in the on-state (Step S113A: Yes), the zoom blur photography controller 301 performs zoom blur photography as described below.

The zoom blur photography controller 301 outputs an instruction signal to the shutter driving unit 11, operates the shutter 10 to set the state of the imaging element 12 to a light-blocked state, and resets the imaging element 12 (Step S113B).

Subsequently, the zoom blur photography controller 301 outputs the instruction signal to the lens controller 42 via the main-body communication unit 28 and the lens communication unit 41, moves the zoom lens 311 to the telephoto end side, and starts zoom operation (Step S113C).

Furthermore, the zoom blur photography controller 301 outputs an instruction signal to the shutter driving unit 11, operates the shutter 10 to set the state of the imaging element 12 to the exposed state, and starts exposure operation of the imaging element 12 (Step S113D).

Subsequently, the zoom blur photography controller 301 determines whether an exposure time determined by the AE processing unit 17 through the execution of the AE process (Step S116) has elapsed since the exposure operation of the imaging element 12 (Step S113D) was started (Step S113E). If the first release signal is not input even once (Step S107: No), and the process at Step S116 is not performed during the series of the processes, the zoom blur photography controller 301 determines, at Step S113E, whether a predetermined time recorded in the flash memory 27 has elapsed.

When determining that the elapsed time of the exposure operation reaches the exposure time (or the predetermined time) (Step S113E: Yes), the zoom blur photography controller 301 outputs an instruction signal to the shutter driving unit 11, operates the shutter 10 to set the state of the imaging element 12 to the light-blocked state, and ends the exposure operation of the imaging element 12 (Step S113F).

Furthermore, the zoom blur photography controller 301 outputs an instruction signal to the lens controller 42 via the main-body communication unit 28 and the lens communication unit 41, stops the movement of the zoom lens 311, and ends the zoom operation (Step S113G).

Then, the zoom blur photography controller 301 outputs an instruction signal to the imaging element driving unit 13, and outputs the image data generated through the above described exposure operation from the imaging element 12 (Step S113H). The image data generated by the imaging element 12 is output to the SDRAM 26 via the signal processing unit 14 and the A/D converter 15. Thereafter, the imaging apparatus 1 returns to the main routine illustrated in FIG. 3.

In contrast, when determining that the setting flag of the zoom blur photography mode is in the off-state (Step S113A: No), the control unit 30 performs normal shooting as described below.

Specifically, the control unit 30 performs the same process as the process of resetting the imaging element 12 (Step S113B), the process of performing the exposure operation of the imaging element 12 (Steps S113D to S113F), and the process of storing the image data (Step S113H) as described above (Steps S1131 to S113M). Thereafter, the imaging apparatus 1 returns to the main routine as illustrated in FIG. 3.

### Rec View Display Process

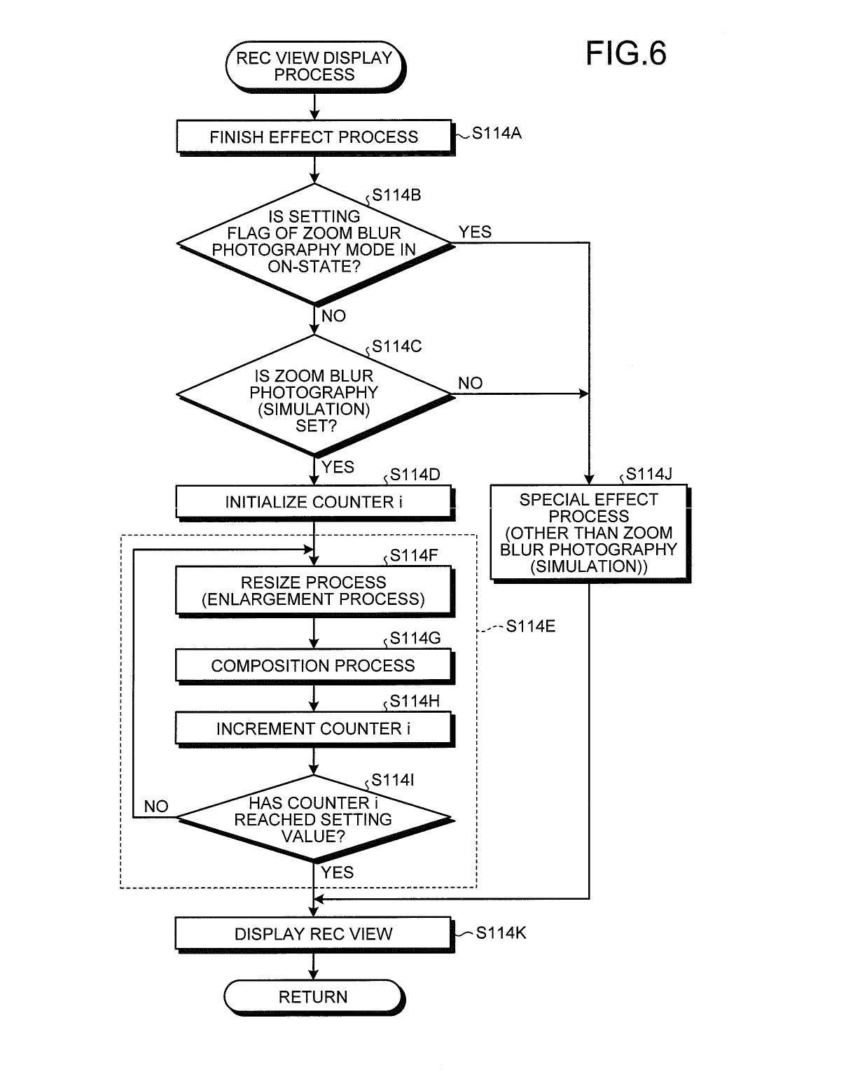

FIG. 6 is a flowchart illustrating an outline of the rec view display process.

The rec view display process (Step S114) illustrated in FIG. 3 will be explained below based on FIG. 6.

The image processing controller 303 causes the basic image processing unit 161 to perform a finish effect process corresponding to the processing item set by the image processing setting unit 302 (Step S104) (the processing item selected on the finish effect process selection screen W3) on the pieces of the image data stored in the SDRAM 26 (Steps S113H and S113M) (the pieces of the image data generated through the zoom blur photography and the normal shooting) (Step S114A).

In the following, image data obtained by performing the finish effect process on the image data generated through the zoom blur photography (Steps S113B to S113H) is described as first finish effect image data. Furthermore, image data obtained by performing the finish effect process on the image data generated through the normal shooting (Steps S113I to S113M) is described as second finish effect image data.

Then, the first finish effect image data and the second finish effect image data are output to the SDRAM 26 via the bus 29.

Subsequently, the control unit 30 determines whether the setting flag of the zoom blur photography mode stored in the SDRAM 26 is in the on-state (Step S114B).

When determining that the setting flag of the zoom blur photography mode is in the off-state (Step S114B: No), the control unit 30 determines whether the processing item of the special effect process set at Step S104 (the processing item selected on the special effect process selection screen W4) is the “zoom blur photography (simulation)” based on the information stored in the SDRAM 26 (Step S114C).

When determining that the set processing item of the special effect process is the “zoom blur photography (simulation)” (Step S114C: Yes), the image processing controller 303 initializes a counter i (i=0) that measures the number of compositions (the number of the resize processes and the composition processes in the iterative process performed by the special image processing unit 162) (Step S114D).

Subsequently, the image processing controller 303 causes the special image processing unit 162 to perform a special effect process (iterative process) corresponding to the “zoom blur photography (simulation)” on the second finish effect image data as described below (Step S114E: a special image processing step).

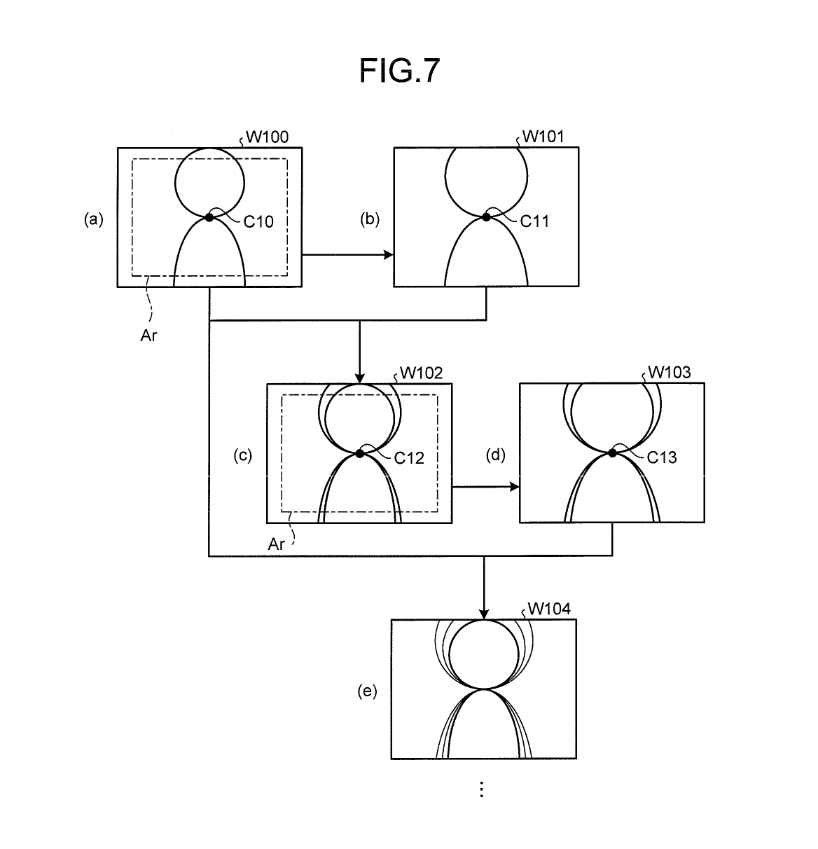

FIG. 7 is a diagram for explaining the special image processing step.

The image processing controller 303 recognizes the current number of compositions from the counter i, and causes the image resize unit 162A to perform a resize process (enlargement process) in accordance with the current number of compositions (Step S114F).

When the current number of compositions is zero (when the first resize process is to be performed), the image resize unit 162A reads out, from the SDRAM 26 via the bus 29, image data corresponding to a partial area Ar ((a) in FIG. 7) in which a center position C10 (optical center) of an image W100 corresponding to the second finish effect image data serves as a center. Then, the image resize unit 162A enlarges the image size of the read image data (the area Ar) to the same size as the image W100 by using the center position C10 (one position according to the present invention) as a center (without changing the position of the center position C10), and generates resize process image data (an image W101 ((b) in FIG. 7)).

The aspect ratio of the area Ar is the same as the aspect ratio of the image W100.

Subsequently, the image processing controller 303 causes the image composition unit 162B to perform the composition process (Step S114G).

When the current number of compositions is zero (when the first composition process is to be performed), the image composition unit 162B reads out the second finish effect image data from the SDRAM 26 via the bus 29. Then, the image composition unit 162B composites the pieces of the image data such that the center position C10 of the image W100 corresponding to the second finish effect image data and a center position C11 of the image W101 corresponding to the resize process image data generated by the image resize unit 162A ((b) in FIG. 7) coincide with each other, and generates composition process image data (an image W102 ((c) in FIG. 7)). The generated composition process image data is output to the SDRAM 26 via the bus 29.

In the composition process (Step S114G), the image composition unit 162B multiplies a signal of each pixel of the second finish effect image data by a coefficient a (0<a≦1), multiplies a signal of each pixel of the resize process image data by a coefficient (1−a), and composites these pieces of the image data.

Subsequently, the image processing controller 303 increments the counter i (i=i+1) (Step S114H), and determines whether the counter i has reached the setting value (the number of compositions) (Step S114I).

In the first embodiment, the setting value (the number of compositions) used at Step S114I is set to, for example, 10.

When determining that the counter i has not reached the setting value (the number of compositions) (Step S114I: No), the imaging apparatus 1 returns to Step S114F.

Then, when performing the second or later resize process (Step S114F), the image resize unit 162A performs the resize process not on the second finish effect image data but on the composition process image data.

For example, when performing the second resize process (Step S114F), the image resize unit 162A reads out, from the SDRAM 26 via the bus 29, the image data corresponding to the partial area ((a) in FIG. 7) in which a center position C12 of the image W102 corresponding to the composition process image data serves as a center. Then, the image resize unit 162A enlarges the image size of the read image data (the area Ar) to the same size as the image W100 by using the center position C12 as a center, and generates resize process image data (an image W103 ((d) in FIG. 7)).

In the first embodiment, at Step S114E, each resize ratio (an enlargement ratio, which is a vertical (horizontal) dimension of the image W100 with respect to the vertical (horizontal) dimension of the area Ar) in each of the repeatedly performed resize processes (Step S114F) is set to be constant.

Furthermore, when performing the second or later composition process (Step S114G), the image composition unit 162B composites the second finish effect image data and the resize process image data in the same manner as in the above described first composition process.

For example, when performing the second composition process (Step S114G), the image composition unit 162B reads out the second finish effect image data from the SDRAM 26 via the bus 29. Then, the image composition unit 162B composites the pieces of the image data such that the center position C10 of the image W100 corresponding to the second finish effect image data and a center position C13 of the image W103 corresponding to the resize process image data generated by the image resize unit 162A ((d) in FIG. 7) coincide with each other, and generates composition process image data (an image W104 ((e) in FIG. 7)). Then, the image composition unit 162B updates the composition process image data stored in the SDRAM 26 with the latest composition process image data.

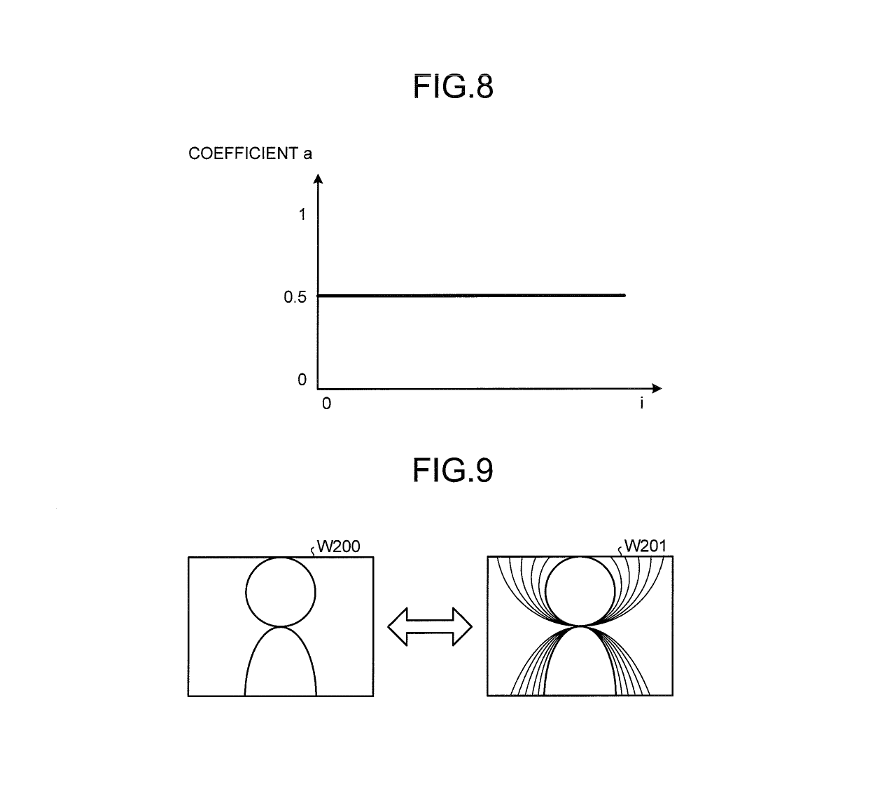

FIG. 8 is a diagram illustrating the coefficient multiplied by the signal of each pixel of the second finish effect image data in each of the repeatedly performed composition processes (Step S114G).

In the first embodiment, as illustrated in FIG. 8, the coefficient a multiplied by the signal of each pixel of the second finish effect image data in the composition process (Step S114G) is set to 0.5 (the signals of all of the pixels are uniformly multiplied by the coefficient a=0.5), and the coefficient a in each of the composition processes to be repeatedly performed (Step S114G) is maintained constant at 0.5.

As a result of repetition from Step S114F to Step S114H, when determining that the counter i has reached the setting value (Step S114I: Yes), the imaging apparatus 1 ends the special effect process corresponding to the “zoom blur photography (simulation)” by the special image processing unit 162 and proceeds to Step S114K.

In contrast, when determining that the setting flag of the zoom blur photography mode is in the on-state (Step S114B: Yes), the image processing controller 303 performs a process as described below (Step S114J).

At Step S114J, the image processing controller 303 causes the special image processing unit 162 to perform a special effect process corresponding to the processing item set by the image processing setting unit 302 (Step S104) (the processing item selected on the special effect process selection screen W4 (a processing item other than the “zoom blur photography (simulation)”)) on the first finish effect image data stored in the SDRAM 26 (Step S114J). Thereafter, the imaging apparatus 1 proceeds to Step S114K.

When determining that the set processing item of the special effect process is not the “zoom blur photography (simulation)” (Step S114C: No), the image processing controller 303 causes, at Step S114J, the special image processing unit 162 to perform the same special effect process as described above (the processing item other than the “zoom blur photography (simulation)”) on the second finish effect image data stored in the SDRAM 26.

After the process at Step S114I, it may be possible to perform the process at Step S114J, that is, a special effect process corresponding to the processing item other than the “zoom blur photography (simulation)” on the composition process image data stored in the SDRAM 26.

At Step S114K, the display controller 304 displays, on the display unit 21, a rec view image corresponding to the image data subjected to the image processing by the image processing unit 16. Thereafter, the imaging apparatus 1 returns to the main routine illustrated in FIG. 3.

FIG. 9 is a diagram illustrating an example of the rec view image displayed on the display unit 21 by the display controller 304.

For example, at Step S114K, when the special effect process corresponding to the “zoom blur photography (simulation)” is performed (Step S114E) (when the composition process image data is stored in the SDRAM 26), as illustrated in FIG. 9, the display controller 304 displays, on the display unit 21, a rec view image W200 corresponding to the second finish effect image data and a rec view image W201 corresponding to the composition process image data by switching from one to the other at predetermined time intervals.

Furthermore, at Step S114K, when the special effect process other than the “zoom blur photography (simulation)” is performed (Step S114J), the display controller 304 displays, on the display unit, a rec view image (not illustrated) corresponding to the image data subjected to the special effect process.

### Live View Display Process

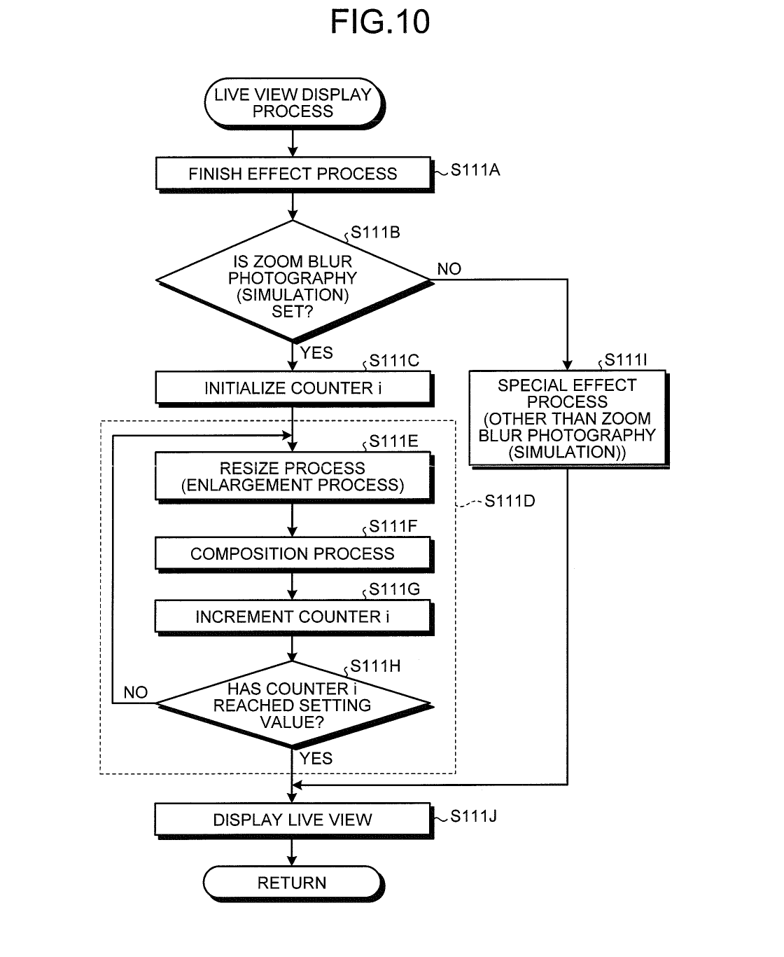

FIG. 10 is a flowchart illustrating an outline of the live view display process.

The live view display process (Steps S111 and S119) illustrated in FIG. 3 will be explained below based on FIG. 10.

The image processing controller 303 causes the basic image processing unit 161 to perform a finish effect process on the image data stored in the SDRAM 26 through the shooting by the electronic shutter (Steps S110 and S118), in the same manner as Step S114A (Step S111A). The finish effect image data generated by the basic image processing unit 161 (hereinafter, described as third finish effect image data) is output to the SDRAM 26 via the bus 29.

Subsequently, the control unit 30 determines whether the processing item of the special effect process set at Step S104 is the “zoom blur photography (simulation)”, in the same manner as Step S114C (Step S111B).

When determining that the set processing item of the special effect process is the “zoom blur photography (simulation)” (Step S111B: Yes), the imaging apparatus 1 performs the process at Step S111C that is the same as Step S114D, and performs the processes at Steps S111E to S111H that are the same as Steps S114F to S114I (Step S111D: a special image processing step). At Step S111D, the image processing controller 303 employs the third finish effect image data instead of the the second finish effect image data as an object to be subjected to the image processing (the special effect process (the iterative process) corresponding to “zoom blur photography (simulation)”), which differs from Step S114E. Thereafter, the imaging apparatus 1 proceeds to Step S111J.

In the first embodiment, the setting value (the number of compositions) used at Step S111H is set to, for example, five for the case where a moving image is being recorded (Step S119), and set to, for example, three for the case where a moving image is not being recorded (Step S111).

In contrast, when determining that the set processing item of the special effect process is not the “zoom blur photography (simulation)” (Step S111B: No), the imaging apparatus 1 performs the process at Step S111I that is the same as Step S114J. At Step S111I, the image processing controller 303 employs the third finish effect image data instead of the first finish effect image data and the second finish effect image data as an object to be subjected to the image processing (the special effect process other than the “zoom blur photography (simulation)”), which differs from Step S114J. Thereafter, the imaging apparatus 1 proceeds to Step S111J.

At Step S111J, the display controller 304 displays, on the display unit 21, a live view image corresponding to the image data subjected to the image processing by the image processing unit 16. Thereafter, the imaging apparatus 1 returns to the main routine illustrated in FIG. 3.

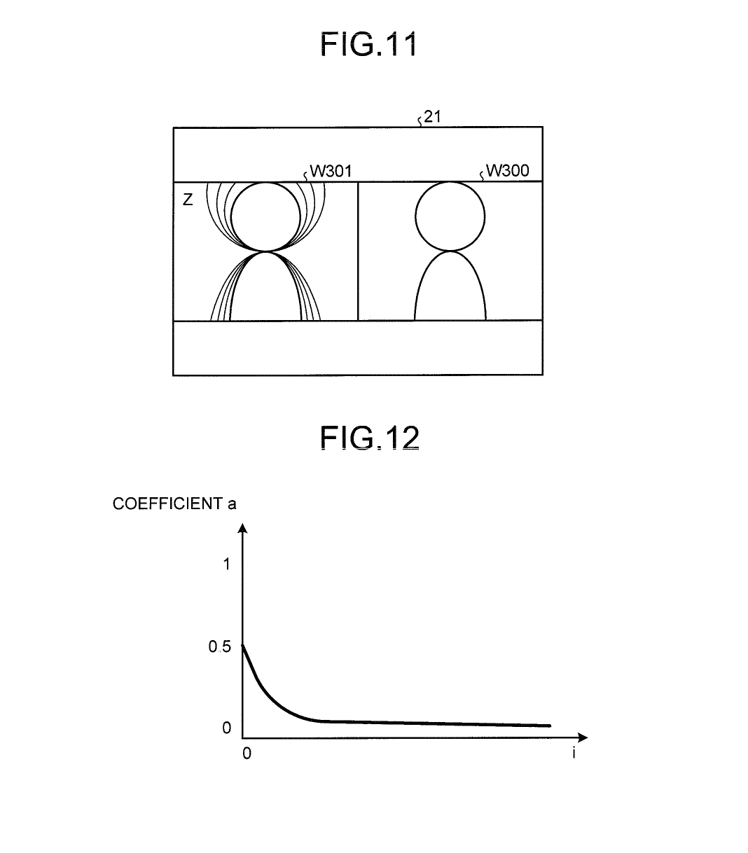

FIG. 11 is a diagram illustrating an example of the live view image displayed on the display unit 21 by the display controller 304.

For example, at Step S111J, when the special effect process corresponding to the “zoom blur photography (simulation)” is performed (Step S111D) (when the composition process image data is stored in the SDRAM 26), as illustrated in FIG. 11, the display controller 304 displays, on the display unit 21, a live view image W300 corresponding to the third finish effect image data and a live view image W301 corresponding to the composition process image data side by side.

In this case, the display controller 304 displays, in a superimposed manner, a letter “Z” as information indicating the “zoom blur photography (simulation)” being the processing item on the live view image W301 displayed on the display unit 21.

Furthermore, at Step S111J, when the special effect process other than the “zoom blur photography (simulation)” is performed (Step S111I), the display controller 304 displays, on the display unit 21, a live view image (not illustrated) corresponding to the image data subjected to the special effect process.

At Steps S111D and S111I, the image data (the third finish effect image data) as an object subjected to the image processing is switched according to the display frame rate at which the the display controller 304 displays the live view image on the display unit 21. Specifically, the processes at Steps S111D and S111I are completed before a live view image of a next frame is displayed. Therefore, for example, on the display unit 21, the live view image corresponding to the image data obtained by performing the image processing (Steps S111D and S111I) on the third finish effect image data of the first frame is first displayed, and thereafter, the live view image corresponding to the image data obtained by performing the image processing (Steps S111D and S111I) on the third finish effect image data of the second frame is displayed.

In the first embodiment as explained above, the imaging apparatus 1 includes the special image processing unit 162 that performs the iterative process (the special image processing step (Steps S114E and S111D)) to repeat the resize process (enlargement process) and the composition process a predetermined number of times. Therefore, it becomes possible to generate an image (for example, the image W104 illustrated in (e) in FIG. 7), in which a zoom effect is simulated such that a subject appearing in the optical center is gradually increased in size by taking the optical center (for example, the center position C10 in (a) in FIG. 7) in the image area of the image data subjected to the image processing as a center.

Furthermore, in the first embodiment, the special image processing unit 162 reads out the image data corresponding to the partial area Ar of the image area of the image data subjected to the image processing in the resize process (Steps S114F and S111E), and enlarges the image size of the read image data. Therefore, for example, the amount of data to be read is reduced as compared to the case where all pieces of the image data subjected to the image processing are read and the image size of each pieces of the image data is enlarged, so that it becomes possible to reduce the processing time of the resize process, enabling to reduce the processing time of the special image processing step.

Moreover, in the first embodiment, the imaging apparatus 1 is able to perform the zoom blur photography. Furthermore, the imaging apparatus 1 includes the display controller 304 that displays the image subjected to the special effect process corresponding to the “zoom blur photography (simulation)” and the image before being subjected to the special effect process, in the rec view display process (Step S114) and the live view display process (Steps S111 and S119). Therefore, it becomes possible to allow a user to compare the images before and after the zoom blur photography and allow the user to recognize what zoom effect is to be applied to the captured image when the zoom blur photography is performed.

### First Modified Example of First Embodiment

FIG. 12 is a diagram illustrating a change in the coefficient a in each of the repeatedly performed composition processes according to a first modified example of the first embodiment of the present invention.

In the above described first embodiment, the coefficient a used in each of the composition processes (Steps S114G and S111F) repeatedly performed in the special image processing step (Steps S114E and S111D) is constant (0.5). Therefore, in the rec view image and the live view image corresponding to the image data subjected to the special effect process of the “zoom blur photography (simulation)”, the sharpness of the enlarged image is reduced as the enlargement ratio increases. Namely, in the rec view image and the live view image, the enlarged image is displayed as an afterimage (for example, (e) in FIG. 7).

The first embodiment is not limited to the above, and it may be possible to set the coefficient a to a different value in each of the composition processes as illustrated in FIG. 12 for example.

Specifically, the coefficient a multiplied by the signal of each pixel of the second finish effect image data may be set to 1/(i+2), and the coefficient (1−a) multiplied by the signal of each pixel of the resize process image data may be set to (i+1)/(i+2). For example, if the number of compositions is one (the counter i=0), the coefficient a becomes “½” according to Expression described above, and if the number of compositions is two (the counter i=1), the coefficient a becomes “⅓” according to Expression described above.

If the coefficient a is changed as described above, in the rec view image and the live view image corresponding to the image data subjected to the special effect process of the “zoom blur photography (simulation)”, the sharpness of all of the images including non-enlarged images and enlarged images becomes the same.

### Second Modified Example of First Embodiment

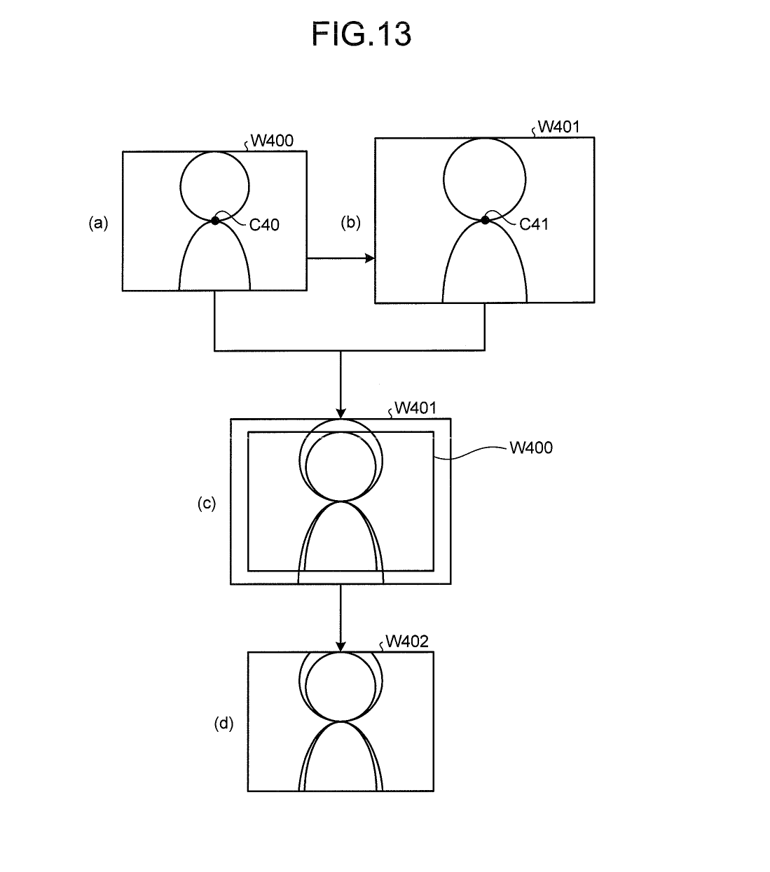

FIG. 13 is a diagram for explaining a special image processing step according to a second modified example of the first embodiment of the present invention.

In the above described first embodiment, in the resize process (Step S114F), the image data of the partial area Ar of the image corresponding to the second finish effect image data (the composition process image data) is read out, and the image size of the read image data is enlarged.

The first embodiment is not limited to the above, and it may be possible to perform the resize process (Step S114F) as illustrated in FIG. 13 for example.

For example, the image resize unit 162A reads out pieces of data of all image areas of the second finish effect image data (the composition process image data) from the SDRAM 26 via the bus 29. Then, the image resize unit 162A enlarges the image size of the read second finish effect image data (the composition process image data) to an image size greater than an image W400 by using a center position C40 ((a) in FIG. 13) of the image W400 corresponding to the second finish effect image data (the composition process image data) as a center, and generates resize process image data (an image W401 ((b) in FIG. 13).

In this case, in the composition process (Step S114G), the image composition unit 162B composites the pieces of the image data such that the center position C40 of the image W400 corresponding to the second finish effect image data (the composition process image data) and a center position C41 of the image W401 corresponding to the resize process image data ((b) in FIG. 13) coincide with each other ((c) in FIG. 13). Then, the image composition unit 162B generates only the image data corresponding to an image area of the image W400 among the composited pieces of the image data, as the composition process image data (an image W402 ((d) in FIG. 13).

At Steps S111E (the resize process) and S111F (the composition process), it may be possible to perform the same process as Steps S114F and S114G.

### Third Modified Example of First Embodiment

In the above described first embodiment, when the special effect process corresponding to the “zoom blur photography (simulation)” is performed, the rec view image W200 corresponding to the second finish effect image data and the rec view image W201 corresponding to the composition process image data are displayed on the display unit 21 such that they are switched from one to the other at predetermined intervals; however, this is not the limitation.

For example, it may be possible to display the images W200 and W201 side by side on the display unit 21. Alternatively, it may be possible to display only the image W201 on the display unit 21.

Furthermore, to display the live view image, similarly to the above, a display mode is not limited to a mode in which the live view image W300 corresponding to the third finish effect image data and the live view image W301 corresponding to the composition process image data are displayed side by side on the display unit 21, and it may be possible to display only the live view image W301 on the display unit 21.

### Second Embodiment

Next, a second embodiment of the present invention will be explained.

In the explanation below, the same configurations and steps as those of the above described first embodiment are denoted by the same symbols, and detailed explanation thereof will be omitted or simplified.

In the above described first embodiment, the setting value (the number of compositions) used at Step S111H in the live view display process (Steps S111 and S119) is a predetermined number of times. Furthermore, in the resize processes to be repeatedly performed (Step S111E), the resize process is performed on the third finish effect image data in the first resize process and the resize process is performed on the composition process image data in the second or later resize process. Moreover, each resize ratio (enlargement ratios) for each of the resize processes to be repeatedly performed (Step S111E) is set to be constant.

In contrast, in the live view display process according to the second embodiment, the setting value (the number of compositions) is changed depending on the display frame rate, and each resize ratio (enlargement ratio) for each resize process is changed depending on the setting value (the number of compositions). Furthermore, in the live view display process according to the second embodiment, in each of the resize processes to be repeatedly performed, the resize process is performed always on the third finish effect image data.

The configuration of the imaging apparatus according to the second embodiment is the same as the configuration of the above described first embodiment.

In the following, only the live view display process according to the second embodiment (Steps S111 and S119 illustrated in FIG. 3) will be explained.

### Live View Display Process

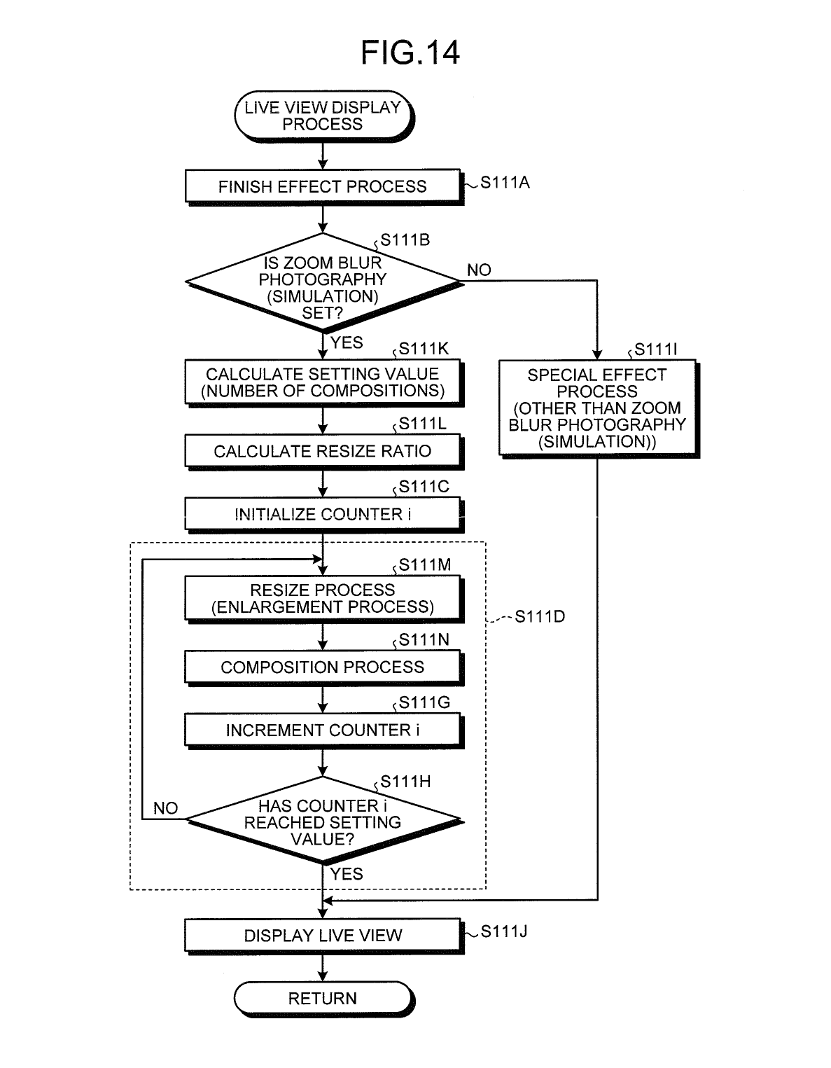

FIG. 14 is a flowchart illustrating an outline of the live view display process according to the second embodiment of the present invention.

The live view display process according to the second embodiment of the present invention differs from the live view display process explained in the above described first embodiment (FIG. 10) only in that, as illustrated in FIG. 14, a setting value (the number of compositions) calculation step (Step S111K) and a resize ratio calculation step (Step S111L) are added and processing contents of the special image processing step (Step S111D) are different. Therefore, only the differences will be described below.

### Setting Value Calculation Step (Step S111K)

The setting value calculation step (Step S111K) is performed after it is determined as “Yes” at Step S111B.

The image processing setting unit 302 according to the second embodiment recognizes the position of the shooting mode changeover switch 203 and acquires a display frame rate corresponding to the shooting mode from the flash memory 27 via the bus 29. Then, the image processing setting unit 302 calculates a setting value (the number of compositions) corresponding to the acquired display frame rate (Step S111K).

Specifically, the image processing setting unit 302 calculates a smaller setting value (the number of compositions) for a higher display frame rate. For example, the setting value (the number of compositions) for the still image shooting mode (the display frame rate: 60 fps) employed as the shooting mode is smaller than the setting value (the number of compositions) for the moving image shooting mode (the display frame rate: 30 fps).

Then, information on the setting value (the number of compositions) calculated by the image processing setting unit 302 is output to the SDRAM 26 via the bus 29.

### Resize Ratio Calculation Step (Step S111L)

Subsequently, the image processing setting unit 302 calculates each resize ratio (enlargement ratio) for each of the resize processes (the enlargement processes at Step S111M to be described later) to be performed repeatedly in the special effect process at Step S111D, based on the calculated setting value (the number of compositions) (Step S111L). Thereafter, the imaging apparatus 1 proceeds to Step S111C.

For example, when the calculated setting value (the number of compositions) is three, the image processing setting unit 302 sets the resize ratios for the first to the third resize processes to 4/3 times, 5/3 times, and 6/3 times, respectively. Furthermore, if the calculated setting value (the number of compositions) is six, the resize ratios of the first to the sixth resize processes are set to 7/6 times, 8/6 times, 9/6 times, 10/6 times, 11/6 times, and 12/6 times, respectively.

Specifically, the image processing setting unit 302 calculates the resize ratio of each of the resize processes such that the resize ratio of the last resize process becomes the same (double in the above described example) regardless of the calculated setting value (the number of compositions).

Then, information on the resize ratios calculated by the image processing setting unit 302 is output to the SDRAM 26 via the bus 29.

### Special Image Processing Step (Step S111D)

The image processing controller 303 according to the second embodiment causes the special image processing unit 162 to perform a special effect process corresponding to the “zoom blur photography (simulation)” at Step S111D (the special image processing step) as described below.

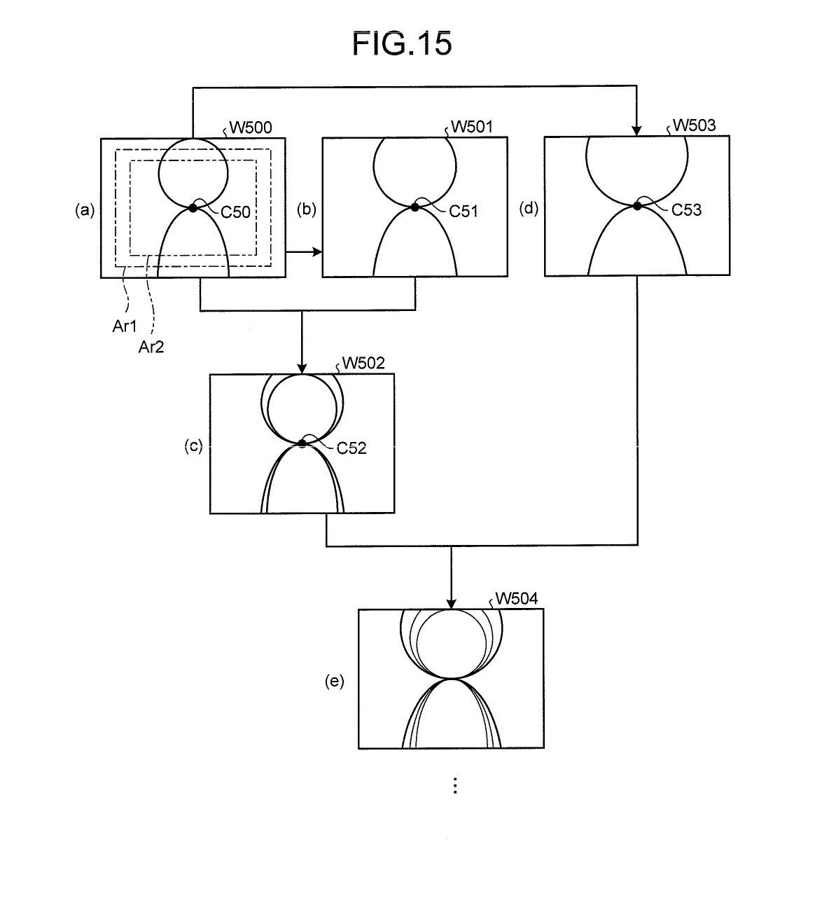

FIG. 15 is a diagram for explaining the special image processing step according to the second embodiment of the present invention (Step S111D).

The image processing controller 303 recognizes the current number of compositions from the counter i, and acquires the resize ratio (enlargement ratio) corresponding to the current number of compositions from the SDRAM 26 via the bus 29. Then, the image processing controller 303 causes the image resize unit 162A to perform the resize process (enlargement process) at the acquired resize ratio (Step S111M).

When the current number of compositions is zero (when the first resize process is to be performed), the image resize unit 162A reads out, from the SDRAM 26 via the bus 29, image data corresponding to a partial area An ((a) in FIG. 15) in which a center position C50 of an image W500 corresponding to the third finish effect image data serves as a center. Then, the image resize unit 162A enlarges the image size of the read image data (the area Art) to the same image size as the image W500 by using the center position C50 as a center, and generates a resize process image data (an image W501 ((b) in FIG. 15).

For example, when the setting value (the number of compositions) is three, the resize ratio for the first resize process is 4/3 times as described above. In this case, the vertical (horizontal) dimension of the area An becomes ¾ of the vertical (horizontal) dimension of the image W200.

Subsequently, the image processing controller 303 recognizes the current number of compositions from the counter i, and causes the image composition unit 162B to perform the composition process in accordance with the current number of compositions (Step S111N).

When the current number of compositions is zero (when the first composition process is to be performed), the image composition unit 162B reads out the third finish effect image data from the SDRAM 26 via the bus 29. Then, the image composition unit 162B composites the pieces of the image data such that the center position C50 of the image W500 corresponding to the third finish effect image data and a center position C51 of the image W501 corresponding to the resize process image data generated by the image resize unit 162A ((b) in FIG. 15) coincide with each other, and generates composition process image data (an image W502 ((c) in FIG. 15). The generated composition process image data is output to the SDRAM 26 via the bus 29.

In the composition process (Step S111N), the coefficient a multiplied by the signal of each pixel of the third finish effect image data and the coefficient (1−a) multiplied by the signal of each pixel of the resize process image data are the same as those of the above described first embodiment.

Subsequently, similarly to the above described first embodiment, the image processing controller 303 increments the counter i (Step S111G), and determines whether the counter i has reached the setting value (the number of compositions) (Step S111H).

In the first embodiment, the setting value (the number of compositions) used at Step S111H is the setting value calculated at Step S111K and is stored in the SDRAM 26.

When determining that the counter i has not reached the setting value (the number of compositions) (Step S111H: No), the imaging apparatus 1 returns to Step S111M.

Then, when performing the second or later resize process (Step S111M), the image resize unit 162A performs the resize process on the third finish effect image data similarly to the first resize process, which differs from the above described first embodiment.

For example, when performing the second resize process (Step S111M), the image resize unit 162A reads out, from the SDRAM 26 via the bus 29, image data corresponding to a partial area Ar2 in which the center position C50 of the image W500 corresponding to the third finish effect image data serves as a center ((a) in FIG. 15). Then, the image resize unit 162A enlarges the image size of the read image data (the area Ar2) to the same size as the image W500 by using the center position C50 as a center, and generates resize process image data (an image W503 ((d) in FIG. 15).

For example, when the setting value (the number of compositions) is three, the resize ratio for the second resize process is 5/3 times as described above. In this case, the vertical (horizontal) dimension the area Ar2 becomes ⅗ of the vertical (horizontal) dimension of the image W200.

Furthermore, when performing the second or later composition process (Step S111N), the image composition unit 162B composites the resize process image data and the composition process image data, which differs from the above described first composition process.

For example, when performing the second composition process (Step S111N), the image composition unit 162B reads out the composition process image data generated through the first composition process from the SDRAM 26 via the bus 29. Then, the image composition unit 162B composites the pieces of the image data such that a center position C52 of the image W502 corresponding to the composition process image data ((c) in FIG. 15) and a center position C53 of the image W503 corresponding to the resize process image data generated by the image resize unit 162A ((d) in FIG. 15) coincide with each other, and generates composition process image data (an image W504 ((e) in FIG. 15). Then, the image composition unit 162B updates the composition process image data stored in the SDRAM 26 with the latest composition process image data.

In the above described second embodiment, advantageous effects as described below are obtained in addition to the same advantageous effects as those of the above described first embodiment.

In the second embodiment, the image processing setting unit 302 changes the setting value (the number of compositions) to a smaller value for a higher display frame rate. Therefore, it becomes possible to complete the special image processing step (Step S111D) before a live view image of a next frame is displayed.

Furthermore, in the second embodiment, the image processing setting unit 302 changes the resize ratio (enlargement ratio) of each of the resize processes (the enlargement process, Step S111M) to be repeatedly performed in the special effect process at Step S111D, in accordance with the changed setting value (the number of compositions). Therefore, even when the display frame rates differ from one another, it becomes possible to approximately equalize the size of a subject in the most enlarged image among multiple images composited through the composition process (for example, the size becomes approximately the same between the still image shooting mode and the moving image shooting mode).

### Modified Example of Second Embodiment

In the above described second embodiment, when the second or later resize process is to be performed (Step S111M), the resize process is performed on the third finish effect image data similarly to the first resize process; however, this is not the limitation.

For example, it may be possible to perform the resize process on the composition process image data in the second or later resize process, similarly to the above described first embodiment.

Furthermore, in the above described second embodiment, the same processes as the resize process (Step S111M) and the composition process (Step S111N) of the live view display process (Steps S111 and S119) may be performed even in the resize process (Step S114F) and the composition process (Step S114G) of the rec view display process (Step S114).

### Third Embodiment

Next, a third embodiment of the present invention will be explained.

In the explanation below, the same configurations and steps as those of the above described first embodiment are denoted by the same symbols, and detailed explanation thereof will be omitted or simplified.

In the above described first embodiment, even when the exposure time determined by the AE processing unit 17 is short, if the setting flag of the zoom blur photography mode is in the on-state, the zoom blur photography is performed.

In contrast, in the third embodiment, if the exposure time determined by the AE processing unit 17 is short, even when the setting flag of the zoom blur photography mode is in the on-state, the zoom blur photography is not performed and a special effect process is performed to generate an image in which a zoom effect is simulated.

The configuration of the imaging apparatus according to the third embodiment is the same as the configuration of the above described first embodiment.

In the following, only shooting by the mechanical shutter according to the third embodiment (Step S113 illustrated in FIG. 3) will be explained.

### Shooting by Mechanical Shutter

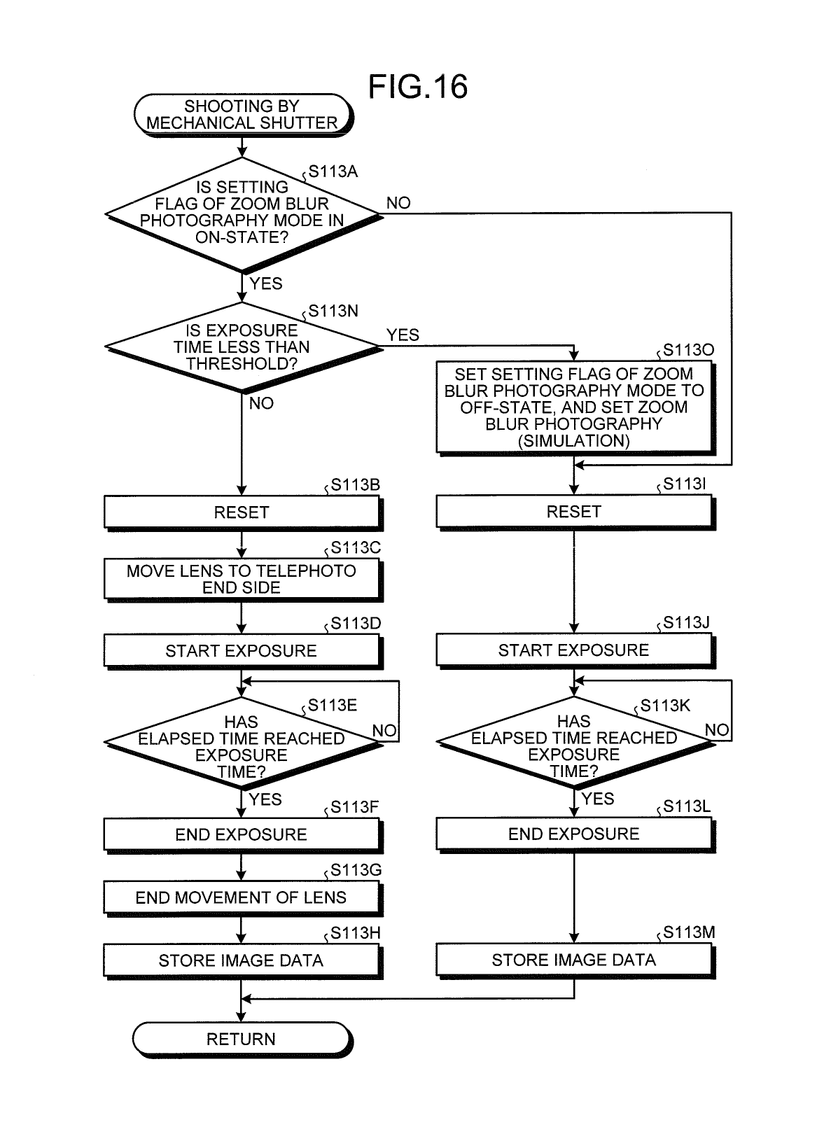

FIG. 16 is a flowchart illustrating an outline of the shooting by the mechanical shutter according to the third embodiment of the present invention.

The shooting by the mechanical shutter according to the third embodiment of the present invention differs from the shooting by the mechanical shutter explained in the above described first embodiment (FIG. 5) only in that, as illustrated in FIG. 16, an exposure time comparison step (Step S113N) and a setting change step (S1130) are added. Therefore, only the differences will be described below.

### Exposure Time Comparison Step (Step S113N)

The exposure time comparison step (Step S113N) is performed after it is determined as “Yes” at Step S113A.

The image processing setting unit 302 according to the third embodiment determines whether the exposure time determined by the AE processing unit 17 through the AE process (Step S116) is less than a threshold recorded in the flash memory 27 (Step S113N).

When it is determined that the exposure time is equal to or more than the threshold (Step S113N: No), the imaging apparatus 1 proceeds to Step S113B.

If the first release signal is not input even once (Step S107: No), and if the process at Step S116 is not performed during the series of the processes, the image processing setting unit 302 determines as “No” at Step S113N similarly to the above.

### Setting Change Step (Step S1130)

When determining that the exposure time is less than the threshold (Step S113N: Yes), the image processing setting unit 302 sets the setting flag of the zoom blur photography mode stored in the SDRAM 26 to the off-state, and sets a processing item of the special effect process performed by the special image processing unit 162 to the “zoom blur photography (simulation)” (Step S1130). Then, information on the special effect process set by the image processing setting unit 302 is output to the SDRAM 26 via the bus 29. Thereafter, the imaging apparatus 1 proceeds to Step S113I.

In the above described third embodiment, advantageous effects as described below are obtained in addition to the same advantageous effects as those of the above described first embodiment.

In the zoom blur photography, if the exposure time is short, the amount of movement of the zoom lens 311 is reduced. Namely, a desired zoom effect is not applied to a captured image obtained through the zoom blur photography.

In the third embodiment, if the exposure time is short, the zoom blur photography is not performed even when the setting flag of the zoom blur photography is in the on-state. Then, the image processing setting unit 302 sets a processing item of the special effect process performed by the special image processing unit 162 to the “zoom blur photography (simulation)”. Therefore, it becomes possible to generate an image in which a zoom effect desired by a user is simulated through the special effect process, instead of performing the zoom blur photography.

### Fourth Embodiment

Next, a fourth embodiment of the present invention will be explained.

In the explanation below, the same configurations and steps as those of the above described first embodiment are denoted by the same symbols, and detailed explanation thereof will be omitted or simplified.

In the above described first embodiment, each resize ratio (enlargement ratio) for each of the resize processes to be repeatedly performed (Steps S111 and S119) in the rec view display process (Step S114) and the live view display process is a predetermined enlargement ratio.

In contrast, in the rec view display process and the live view display process according to the fourth embodiment, each resize ratio for each of the resize processes to be repeatedly performed is changed in accordance with the exposure time determined by the AE processing unit 17.

The configuration of the imaging apparatus according to the fourth embodiment is the same as the configuration of the above described first embodiment.

In the following, only the rec view display process (Step S114 illustrated in FIG. 3) and the live view display process (Steps S111 and S119 illustrated in FIG. 3) according to the fourth embodiment will be explained.

### Rec View Display Process

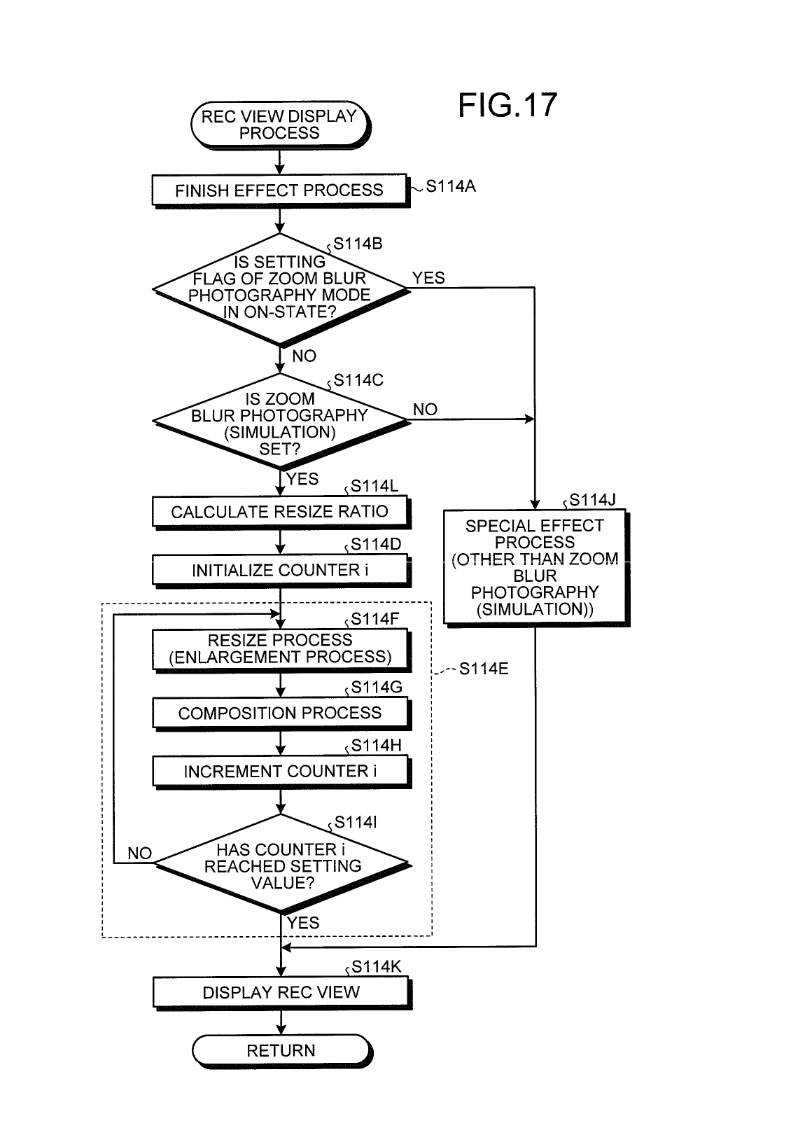

FIG. 17 is a flowchart illustrating an outline of the rec view display process according to the fourth embodiment of the present invention.

The rec view display process according to the fourth embodiment of the present invention differs from the rec view display process of the above described first embodiment (FIG. 6) only in that, as illustrated in FIG. 17, a resize ratio calculation step (Step S114L) is added. Therefore, only the difference will be described below.

The resize ratio calculation step (Step S114L) is performed after it is determined as “Yes” at Step S114C.

The image processing setting unit 302 according to the fourth embodiment calculates the resize ratio (enlargement ratio) for each of the resize processes (Step S114F) to be repeatedly performed in the special effect process at Step S114E, based on the exposure time determined by the AE processing unit 17 through the execution of the AE process (Step S116) (Step S114L). Thereafter, the imaging apparatus 1 proceeds to Step S114D.

Specifically, the image processing setting unit 302 calculates a greater resize ratio (enlargement ratio) for a longer exposure time.

Then, information on the resize ratio (enlargement ratio) calculated by the image processing setting unit 302 is output to the SDRAM 26 via the bus 29.

As described above, the image processing setting unit 302 according to the fourth embodiment has a function as a resize ratio setting unit according to the present invention.

Thereafter, in the resize process to be performed (Step S114F), the image processing controller 303 reads out the resize ratio (enlargement ratio) stored in the SDRAM 26, and causes the image resize unit 162A to perform the resize process (enlargement process) at the resize ratio similarly to the above described first embodiment.

### Live View Display Process

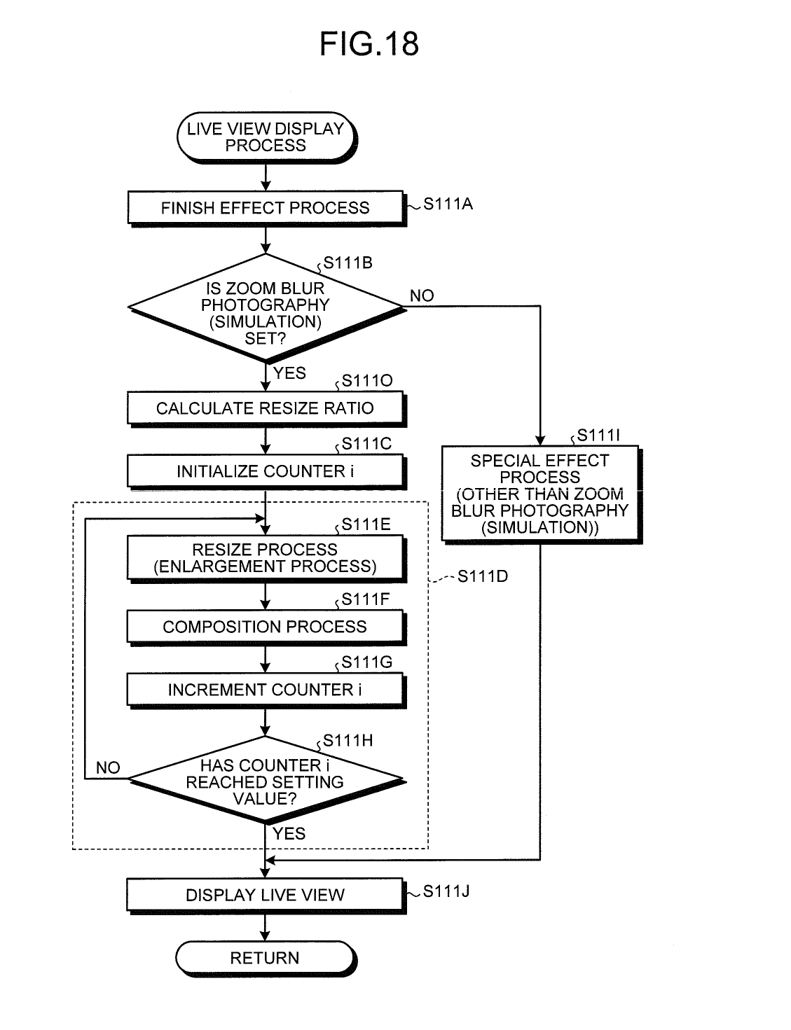

FIG. 18 is a flowchart illustrating an outline of the live view display process according to the fourth embodiment of the present invention.

The live view display process according to the fourth embodiment of the present invention differs from the live view display process (FIG. 10) of the above described first embodiment only in that, as illustrated in FIG. 18, the same resize ratio calculation step (Step S1110) as Step S114L is added.

In the above described fourth embodiment, advantageous effects as described below are obtained in addition to the same advantageous effects as those of the above described first embodiment.

In the zoom blur photography, if the exposure time is long, the amount of movement of the zoom lens 311 is increased.

In the fourth embodiment, the image processing setting unit 302 changes the resize ratio (enlargement ratio) to a greater value for a longer exposure time. Therefore, it becomes possible to approximately equalize the zoom effect applied to a captured image by the zoom blur photography and the zoom effect simulated by the special image process. Therefore, the user can estimate a result of a captured image to be obtained by the zoom blur photography, by confirming an image subjected to the special image process without actually performing the zoom blur photography.

### Modified Example of Fourth Embodiment

In the above described fourth embodiment, the setting value (the number of compositions) at the special image processing step (Steps S114E and S111D) is a predetermined number; however, this is not the limitation.

For example, in the rec view display process (Step S114) or the live view display process (Steps S111 and S119), the image processing setting unit 302 may calculate a setting value (the number of compositions) corresponding to the exposure time determined by the AE processing unit 17 through the execution of the AE process (Step S116), before the special image processing step. Then, in the special image processing step (Steps S114E and S111D), the image processing controller 303 uses the setting value (the number of compositions) calculated by the image processing setting unit 302.

In this case, the image processing setting unit 302 calculates a greater setting value (the number of compositions) for a longer exposure time.

If the first release signal is not input even once (Step S107: No), and a process at Step S116 is not performed during the series of the processes, the image processing setting unit 302 employs the predefined number recorded in the flash memory 27 as the setting value (the number of compositions).

### Fifth Embodiment

Next, a fifth embodiment of the present invention will be explained.

In the explanation below, the same configurations and steps as those of the above described first embodiment are denoted by the same symbols, and detailed explanation thereof will be omitted or simplified.

In the above described first embodiment, in the zoom blur photography (Steps S113B to S113H), shooting is performed while moving the zoom lens 311 to the telephoto end side in order to apply a zoom effect to a captured image such that a subject is gradually increased in size. Furthermore, in the special effect process of the zoom blur photography (simulation) (Steps S114E and S111D), to simulate the zoom effect in which a subject is gradually increased in size, the enlargement process to enlarge the image size is performed in the resize process (Steps S114F and S111E).

In contrast, in the zoom blur photography according to the fifth embodiment, a zoom effect is applied to a captured image such that a subject is gradually reduced in size. Furthermore, in conformity with the above, in the special effect process of the zoom blur photography (simulation) according to the fifth embodiment, the zoom effect is simulated such that a subject is gradually reduced in size. Moreover, the imaging apparatus (the main body) according to the fifth embodiment includes a RAW resize unit to reduce an image size, in addition to the image resize unit 162A, in the imaging apparatus 1 of the above described first embodiment. The other configurations are the same as those of the above described first embodiment.

### Configuration of Imaging Apparatus

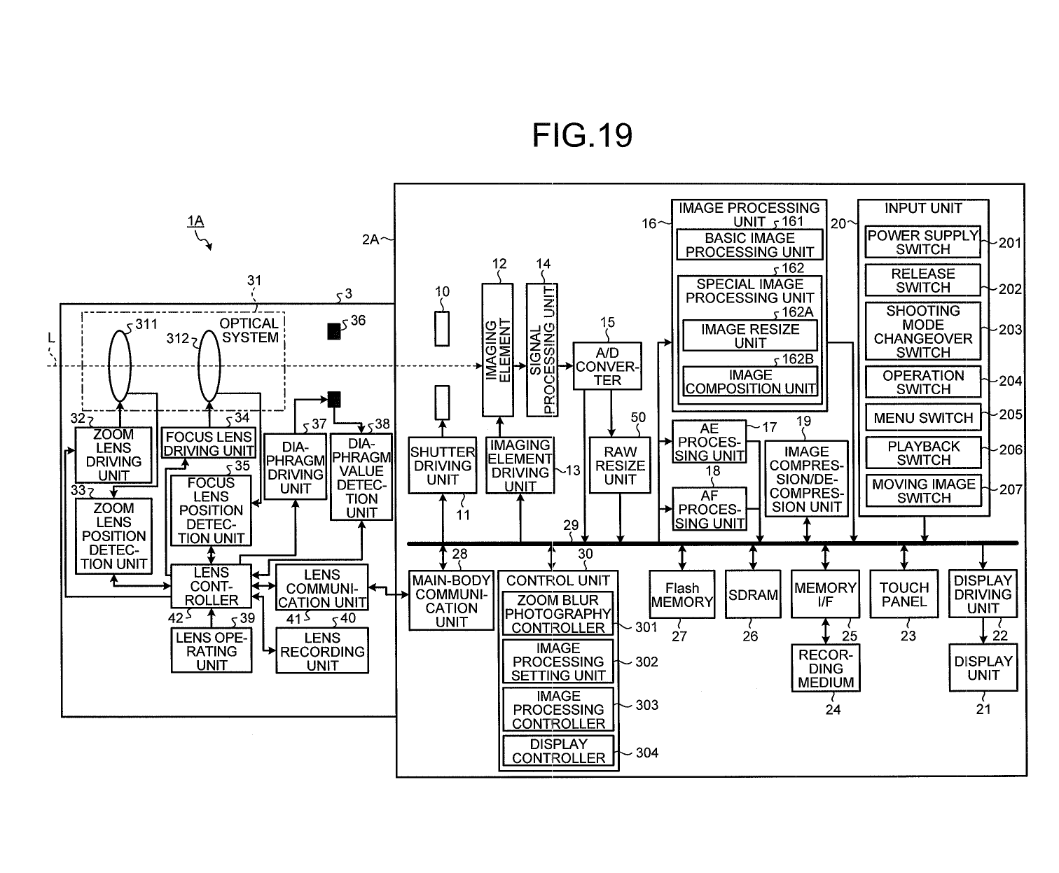

FIG. 19 is a block diagram illustrating the configuration of the imaging apparatus according to the fifth embodiment of the present invention.

An imaging apparatus 1A (a main body 2A) according to the fifth embodiment of the present invention further includes, compared to the imaging apparatus 1 (FIG. 2) of the above described first embodiment, a RAW resize unit 50 as illustrated in FIG. 19.

The A/D converter 15 according to the fifth embodiment outputs generated digital image data to the SDRAM 26 and the RAW resize unit 50 via the bus 29.

The RAW resize unit 50 performs a RAW resize process of reducing the image size of the image data input from the A/D converter 15 at a predetermined ratio (hereinafter, described as a RAW resize ratio) by using one position in an image area of the image data as a center, and generates RAW resize image data. Then, the generated RAW resize image data is output to the SDRAM 26 via the bus 29.

Namely, the RAW resize unit 50 functions as an image reduction unit according to the present invention.

### Operation of Imaging Apparatus

The operation of the imaging apparatus 1A according to the fifth embodiment of the present invention differs from the operation of the imaging apparatus 1 of the above described first embodiment (FIG. 3) in that the processing contents of the shooting by the mechanical shutter (Step S113), the rec view display process (Step S114), the shooting by the electronic shutter (Step S118), and the live view display process (Steps S111 and S119) are different. Therefore, only the differences will be described below.

### Shooting by Mechanical Shutter

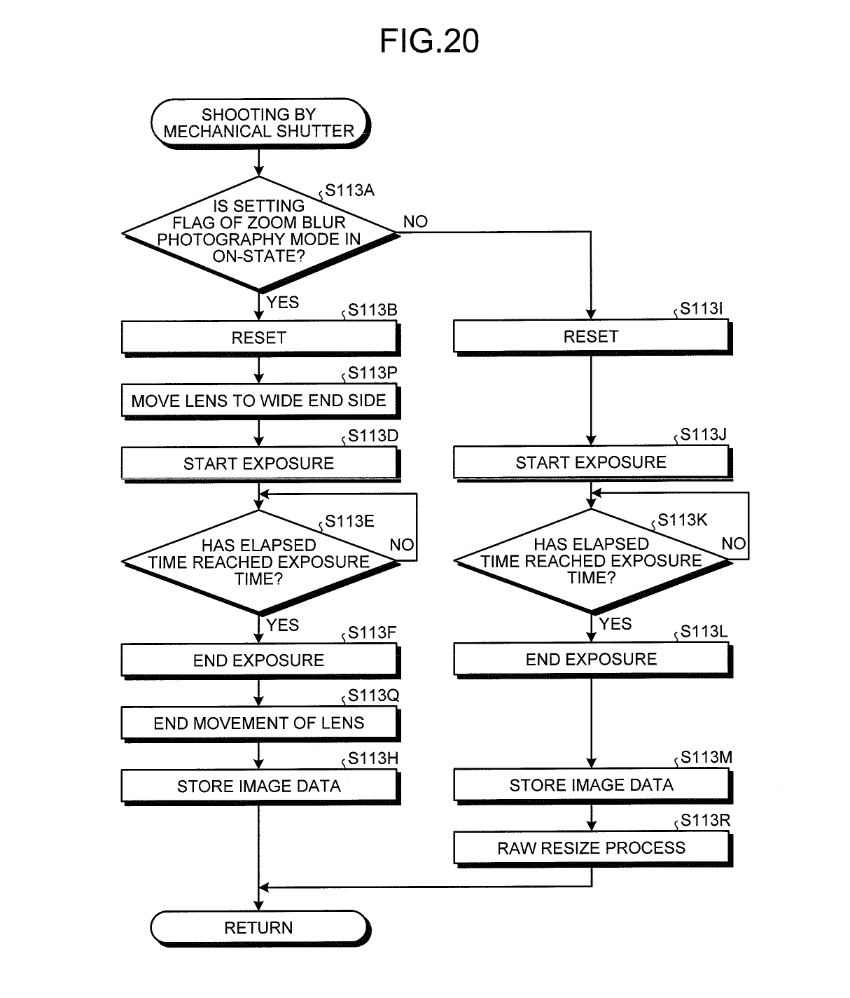

FIG. 20 is a flowchart illustrating an outline of the shooting by the mechanical shutter according to the fifth embodiment of the present invention (Step S113 in FIG. 3).

The zoom blur photography controller 301 according to the fifth embodiment performs, in the zoom blur photography as illustrated in FIG. 20, zoom operation different from Steps S113C and S113G of the above described first embodiment (Steps S113P and S113Q).

Specifically, at Step S113P, the zoom blur photography controller 301 outputs an instruction signal to the lens controller 42 via the main-body communication unit 28 and the lens communication unit 41, and starts zoom operation to move the zoom lens 311 to a wide end side.

Then, after the imaging element 12 completes the exposure operation (Step S113F), the zoom blur photography controller 301 outputs, at Step S113Q, an instruction signal to the lens controller 42 via the main-body communication unit 28 and the lens communication unit 41 to stop movement of the zoom lens 311, and ends the zoom operation.

Furthermore, as illustrated in FIG. 20, after the normal shooting (Steps S113I to S113M), the RAW resize unit 50 performs a RAW resize process (Step S113R).

Specifically, the RAW resize unit 50 reduces the image size of image data that is output by the imaging element 12 through the normal shooting and input via the signal processing unit 14 and the A/D converter 1, at the RAW resize ratio by using the center position of an image of the image data as a center, and generates RAW resize image data. Then, the generated RAW resize image data is output to the SDRAM 26 via the bus 29.

### Rec View Display Process

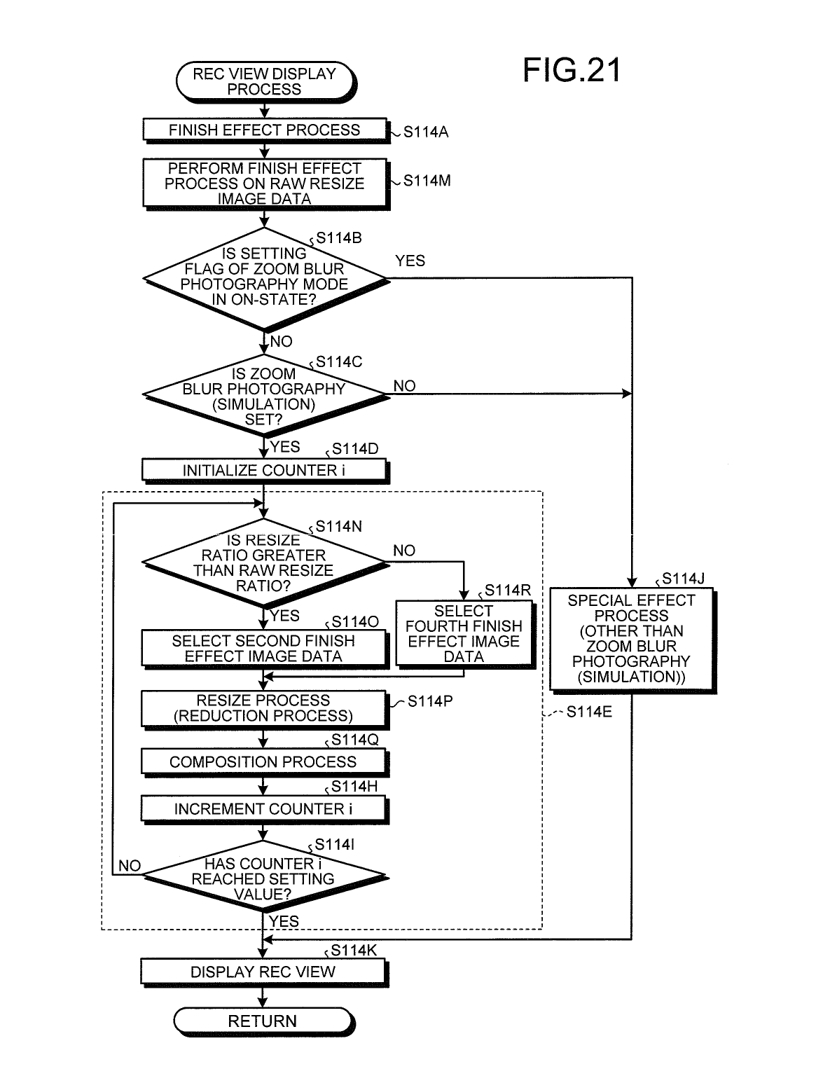

FIG. 21 is a flowchart illustrating an outline of the rec view display process according to the fifth embodiment of the present invention (Step S114 illustrated in FIG. 3).

The image processing controller 303 according to the fifth embodiment causes, similarly to the above described first embodiment, the basic image processing unit 161 to perform the finish effect process on the pieces of the image data that is not subjected to the RAW resize process (the pieces of the image data generated through the zoom blur photography and the normal shooting) (Step S114A). Furthermore, the image processing controller 303 causes the basic image processing unit 161 to perform the same finish effect process on the RAW resize image data stored in the SDRAM 26 (Step S114M).

In the following, similarly to the first embodiment, image data obtained by performing the finish effect process on the image data generated through the zoom blur photography (Steps S113B, S113P, S113D to S113F, S113Q, and S113H) is described as the first finish effect image data, and image data obtained by performing the finish effect process on the image data generated through the normal shooting (S113I to S113M) is described as the second finish effect image data. Furthermore, image data obtained by performing the finish effect process on the RAW resize image data is described as fourth finish effect image data.

Then, the first finish effect image data, the second finish effect image data, and the fourth finish effect image data generated by the basic image processing unit 161 are output to the SDRAM 26 via the bus 29.

Furthermore, at Step S114E (the special image processing step), the image processing controller 303 causes the special image processing unit 162 to perform the special effect process corresponding to the “zoom blur photography (simulation)” as described below.

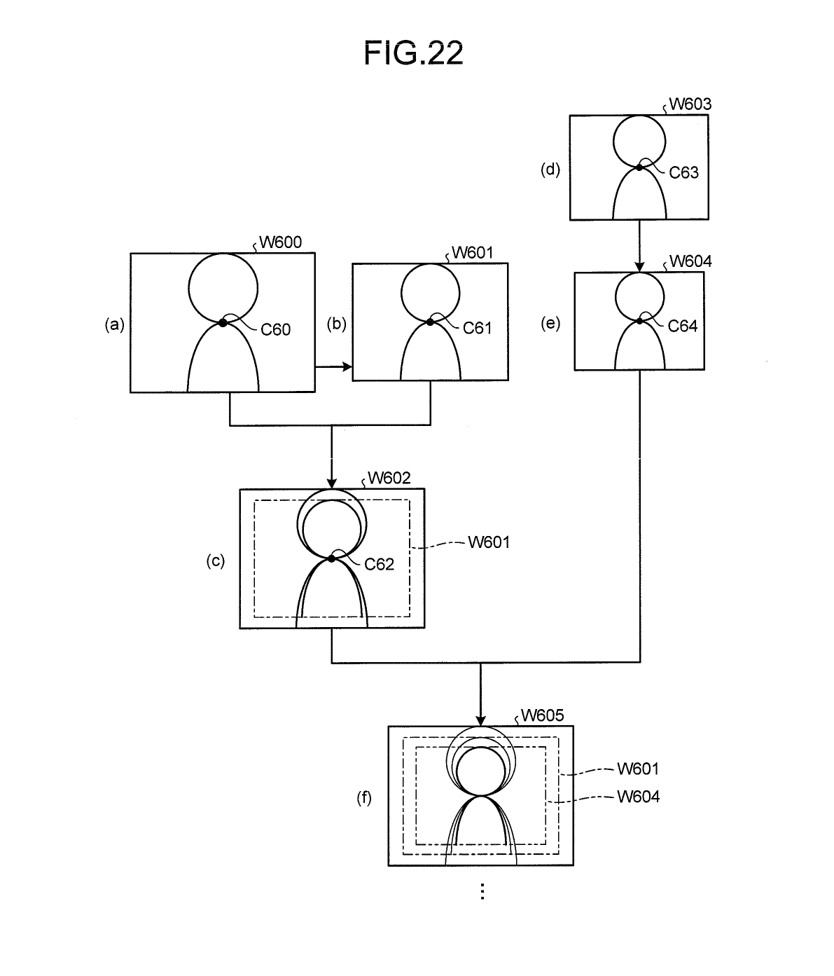

FIG. 22 is a diagram for explaining the special image processing step according to the fifth embodiment of the present invention (Step S114E).

The resize process according to the fifth embodiment is a process of reducing the image size of image data, which differs from the above described first embodiment. Furthermore, in the special image processing step (Step S114E), resize ratios for the respective resize processes to be repeatedly performed are set such that they differ from one another and are reduced as the number of repetitions increases. Then, information on each resize ratio is recorded in the flash memory 27.

The image processing controller 303 recognizes the current number of compositions from the counter i, and reads out the resize ratio corresponding to the current number of compositions from the flash memory 27 via the bus 29. Then, the image processing controller 303 compares the read resize ratio with the RAW resize ratio to determine whether the read resize ratio is greater than the RAW resize ratio (Step S114N).

When determining that the read resize ratio is greater than the RAW resize ratio (Step S114N: Yes), the image processing controller 303 selects the second finish effect image data as image data to be subjected to the resize process (Step S1140).

Subsequently, the image processing controller 303 causes the image resize unit 162A to perform the resize process (reduction process) on the second finish effect image data selected at Step S1140 at the read resize ratio described above (Step S114P).

When the second finish effect image data is selected at Step S1140 and the first resize process is to be performed, the image resize unit 162A reads out the second finish effect image data from the SDRAM 26 via the bus 29. Then, the image resize unit 162A reduces the image size of the read second finish effect image data by using a center position C60 ((a) in FIG. 22) of an image W600 corresponding to the second finish effect image data as a center, and generates resize process image data (an image W601 ((b) in FIG. 22).

Subsequently, the image processing controller 303 recognizes the current number of compositions from the counter i, and causes the image composition unit 162B to perform the composition process in accordance with the current number of compositions (Step S114Q).

When performing the first composition process, the image composition unit 162B reads out the second finish effect image data from the SDRAM 26 via the bus 29. Then, the image composition unit 162B composites the pieces of the image data such that the center position C60 of the image W600 corresponding to the second finish effect image data and a center position C61 of the image W601 corresponding to the resize process image data generated by the image resize unit 162A ((b) in FIG. 22) coincide with each other, and generates composition process image data (an image W602 ((c) in FIG. 22)). The generated composition process image data is output to the SDRAM 26 via the bus 29.

In the composition process (Step S114Q), the image composition unit 162B multiplies the signal of each pixel of the resize process image data by a coefficient b (0<b 1), multiplies the signal of each pixel of the second finish effect image data by a coefficient (1−b), and composites these pieces of the image data.

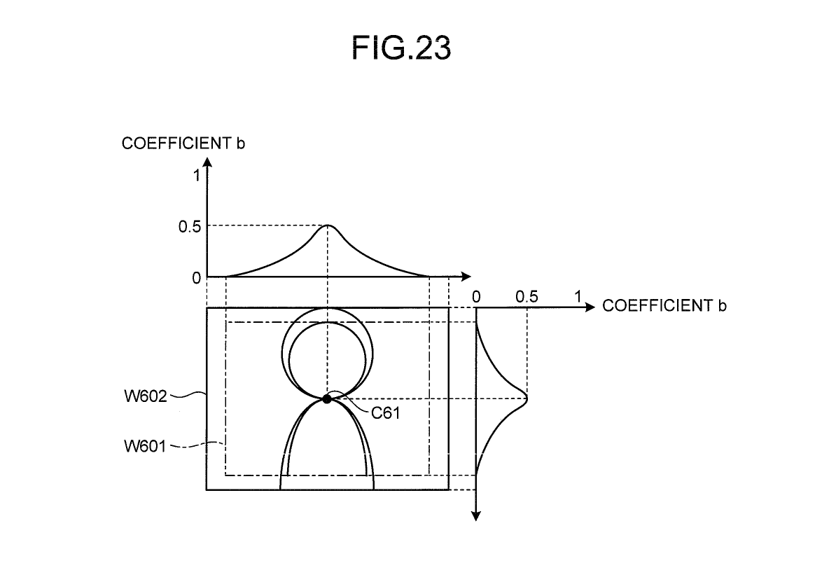

FIG. 23 is a diagram illustrating the coefficient multiplied by the signal of each pixel of the resize process image data in the composition process according to the fifth embodiment of the present invention (Step S114Q).

In FIG. 23, the coefficient b multiplied by the signal of each pixel in the X direction (the left-right direction in FIG. 23) passing through the center position C61 of the image W601 corresponding to the resize process image data is illustrated in the upper part of FIG. 23, and the coefficient b multiplied by the signal of each pixel in the Y direction (the up-down direction in FIG. 23) passing through the center position C61 is illustrated on the right side in FIG. 23.

In the fifth embodiment, the coefficient b multiplied by the signal of each pixel of the resize process image data in the composition process (Step S114Q) is set as illustrated in FIG. 23.

Specifically, the coefficient b is set such that the coefficient b to be multiplied by the signal of the pixel of the center position C61 of the image W601 corresponding to the resize process image data becomes 0.5 which is the highest, such that the coefficient b is reduced as a distance from the center position C61 increases, and such that the coefficient b to be multiplied by the signal of a pixel at a position on the outer edge of the image W601 becomes zero.

The coefficient b in each of the repeatedly performed composition processes (Step S114Q) is set to be constant for each pixel.

Subsequently, similarly to the above described first embodiment, the image processing controller 303 increments the counter i (Step S114H) and determines whether the counter i has reached the setting value (the number of compositions) (Step S114I).

When determining that the counter i has not reached the setting value (Step S114I: No), the imaging apparatus 1 proceeds to Step S114N.

In contrast, when determining that the read resize ratio is smaller than the RAW resize ratio (Step S114N: No), the image processing controller 303 selects the fourth finish effect image data as image data to be subjected to the resize process (Step S114R).

Thereafter, at Step S114P, the image processing controller 303 causes the image resize unit 162A to perform the resize process (reduction process) at the read resize ratio described above such that the image size of the image to be obtained by the resize process becomes the same as the image size of the image obtained by performing the resize process on the second finish effect image data.

For example, when the second resize process (Step S114P) is to be performed, and if the fourth finish effect image data is selected at Step S114R, the image resize unit 162A reads out the fourth finish effect image data from the SDRAM 26 via the bus 29. Then, the image resize unit 162A reduces the image size of the read fourth finish effect image data by using a center position C63 of an image W603 corresponding to the fourth finish effect image data ((d) in FIG. 22) as a center, and generates resize process image data (an image W604 ((e) in FIG. 22).

Furthermore, when performing the second or later composition process (Step S114Q), the image composition unit 162B composites the resize process image data and the composition process image data, which differs from the above described first composition process.

For example, when performing the second composition process (Step S114Q), the image composition unit 162B reads out the composition process image data generated through the first composition process from the SDRAM 26 via the bus 29. Then, the image composition unit 162B composites the pieces of the image data such that a center position C62 of the image W602 corresponding to the composition process image data ((c) in FIG. 22) and a center position C64 of the image W604 corresponding to the resize process image data generated by the image resize unit 162A ((e) in FIG. 22) coincide with each other, and generates composition process image data (an image W605 ((f) in FIG. 22). Then, the image composition unit 162B updates the composition process image data stored in the SDRAM 26 with the latest composition process image data.

### Shooting by Electronic Shutter

In the fifth embodiment, the image data generated by the imaging element 12 through the shooting by the electronic shutter (Step S118) is output to the SDRAM 26 via the signal processing unit 14, the A/D converter 15, and the bus 29 and to the RAW resize unit 50 via the signal processing unit 14 and the A/D converter 15.

Then, the RAW resize unit 50 performs the RAW resize process to reduce, at the RAW resize ratio, the image size of the image data input from the A/D converter 15 by using the center position of an image corresponding to the image data as a center, and generates RAW resize image data. Then, the generated RAW resize image data is output to the SDRAM 26 via the bus 29.

### Live View Display Process

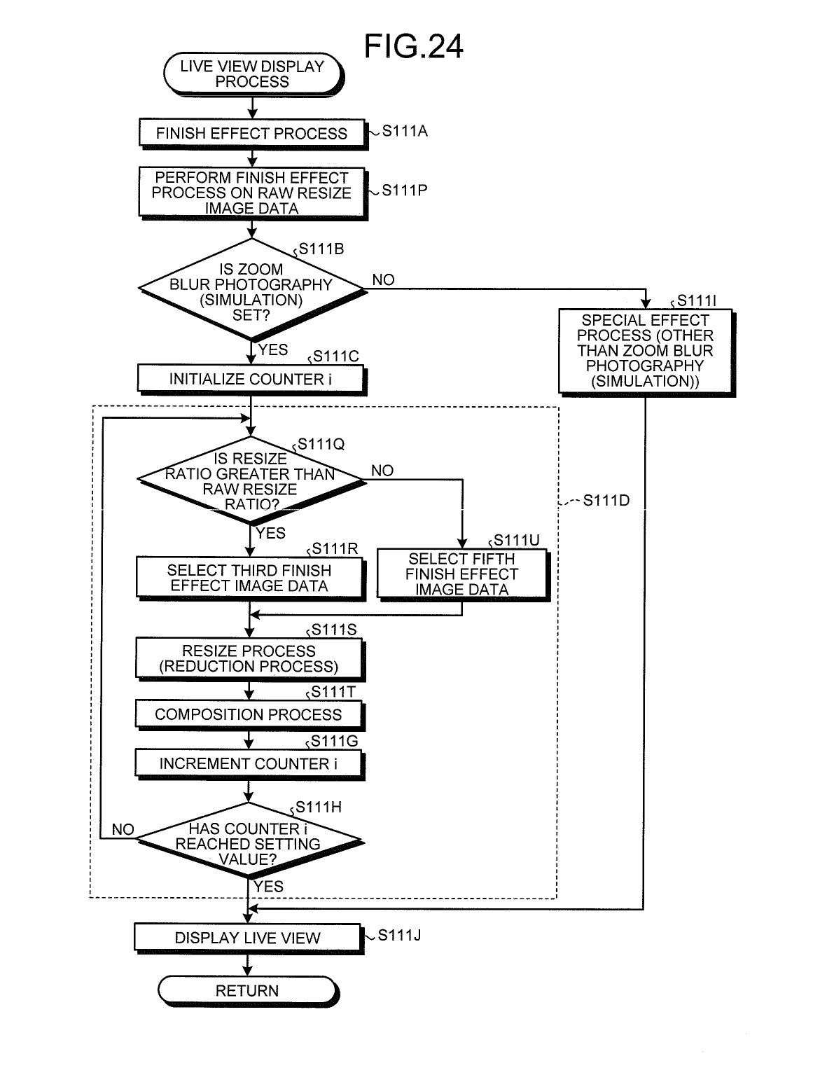

FIG. 24 is a flowchart illustrating an outline of the live view display process according to the fifth embodiment of the present invention (Steps S111 and S119).

The image processing controller 303 according to the fifth embodiment causes, similarly to the above described first embodiment, the basic image processing unit 161 to perform the finish effect process and generates the third finish effect image data (Step S111A). Furthermore, the image processing controller 303 causes the basic image processing unit 161 to perform the same finish effect process on the RAW resize image data stored in the SDRAM 26 and generates fifth finish effect image data (Step S111P).

Then, the third finish effect image data and the fifth finish effect image data are output to the SDRAM 26 via the bus 29.

Furthermore, at Step S111D (the special image processing step), the image processing controller 303 performs the processes at Steps S111Q to S111U similarly to Steps S114N to S114R in the rec view display process (Step S114). At Step S111D, unlike Step S114E, the image processing controller 303 employs the fifth finish effect image data instead of the fourth finish effect image data and employs the third finish effect image data instead of the second finish effect image data as data to be subjected to the image processing (the special effect process (iterative process) corresponding to “zoom blur photography (simulation)”).

In the above described fifth embodiment, advantageous effects as described below are obtained in addition to the same advantageous effects as those of the above described first embodiment.

In the fifth embodiment, the special image processing unit 162 performs the resize process (reduction process) to reduce the image size. Therefore, it becomes possible to generate an image (for example, the image W605 illustrated in (f) in FIG. 22), in which a zoom effect is simulated such that a subject appearing in the optical center is gradually reduced in size by taking the optical center (for example, the center position C60 in (a) in FIG. 22) in the image area of the image data subjected to the image processing as a center.

Furthermore, in the fifth embodiment, in the composition process (Step S114Q), the coefficient b to be multiplied by the signal of each pixel of the resize process image data is set such that the coefficient b is reduced as a distance from the center position C61 of the image W601 corresponding to the resize process image data increases and such that the coefficient b to be multiplied by the signal of a pixel at a position on the outer edge of the the image W601 becomes zero. Therefore, in the image corresponding to the composition process image data (for example, the image W602 or W605 in (c) or (f) in FIG. 22), it becomes possible to make the position of the outer edge of the image (for example, the image W601 or W604 in (c) or (f) in FIG. 22) corresponding to the resize process image data unnoticeable, so that a natural image can be obtained.

Meanwhile, the second finish effect image data and the third finish effect image data that are not subjected to the RAW resize process have grater image sizes and data amounts as compared to those of the fourth finish effect image data and the fifth finish effect image data subjected to the RAW resize process.

In the fifth embodiment, when the resize ratio for the resize process (S114P and S111S) is relatively small, the special image processing unit 162 reads out the fourth finish effect image data and the fifth finish effect image data that have already been reduced by the RAW resize unit 50, and then performs the resize process. Therefore, as compared to the case where, for example, the second finish effect image data and the third finish effect image data are read and then the resize process is performed, the amount of data to be read is small, so that it becomes possible to reduce the processing time for the resize process, enabling to reduce the processing time for the special image processing step (Steps S114E and S111D).

### Sixth Embodiment

Next, a sixth embodiment of the present invention will be explained.

In the explanation below, the same configurations and steps as those of the above described first embodiment are denoted by the same symbols, and detailed explanation thereof will be omitted or simplified.

In the above described first embodiment, in the resize process (Steps S114F and S111E), the center of expansion (one position according to the present invention) is set to the optical center.

In contrast, in the sixth embodiment, in the various conditions setting process, the center of expansion can be set through the user touch operation.

The configuration of the imaging apparatus according to the sixth embodiment is the same as the configuration of the above described first embodiment.

In the following, only the various conditions setting process (Step S104 in FIG. 3) and the resize process (Step S114F in FIG. 6 and Step S111E in FIG. 10) according to the sixth embodiment will be explained.

### Various Conditions Setting Process

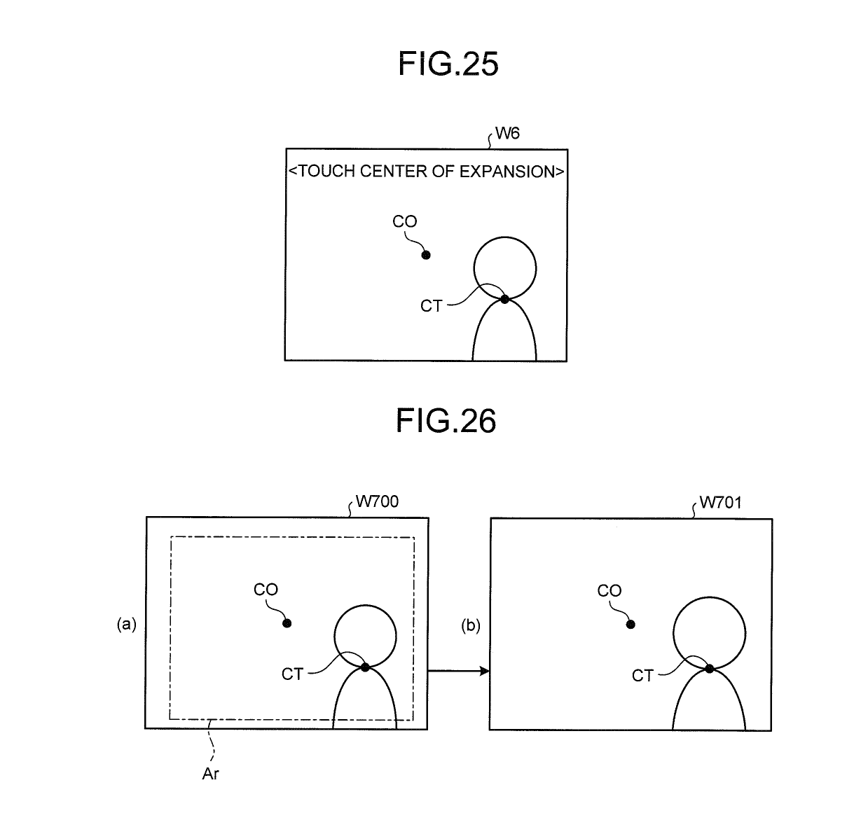

FIG. 25 is a diagram illustrating a part of screen transition of the menu screen displayed on the display unit 21 when the menu switch 205 according to the sixth embodiment is operated.

When the zoom blur photography (simulation) icon A46 is selected through the user touch operation while the special effect process selection screen W4 ((d) in FIG. 4) is being displayed on the display unit 21, the display controller 304 according to the sixth embodiment displays a live view image W6 on the display unit 21 as illustrated in FIG. 25.

The live view image W6 is a screen for causing the user to set the center of expansion by touch operation, and letters “touch center of expansion” is displayed in a superimposed manner.

Then, when a position CT illustrated in FIG. 25 is touched by the user touch operation while the live view image W6 is being displayed on the display unit 21 for example, the image processing setting unit 302 according to the sixth embodiment sets the touched position CT (for example, the position of the center of gravity of a contact area (touch area) on the touch screen through the touch operation), instead of the optical center CO, as the center of expansion in the resize process. Information on the center CT of expansion set by the image processing setting unit 302 is output to the SDRAM 26 via the bus 29.

Namely, the image processing setting unit 302 according to the sixth embodiment has a function as a center position setting unit according to the present invention.

### Resize Process

FIG. 26 is a diagram for explaining the resize process according to the sixth embodiment (Step S114F in FIG. 6 and Step S111E in FIG. 10).

As explained in the above described first embodiment, in the special image processing step (Steps S114E and S111D), the first resize process and the second or later resize process differ from each other only in that the image data to be subjected to the image processing is different (for the first time: the second finish effect image data and the third finish effect image data, and for the second or later time: the composition process image data). Therefore, only the first resize process will be explained below.

The image processing controller 303 reads out information on the center CT of expansion from the SDRAM 26 via the bus 29. Then, the image processing controller 303 causes the image resize unit 162A to perform the resize process (enlargement process) by using the center CT of expansion as a center.

The image resize unit 162A reads out, from the SDRAM 26 via the bus 29, image data corresponding to the partial area Ar including the center CT of expansion in an image W700 ((a) in FIG. 26) corresponding to the second finish effect image data (the third finish effect image data) to be subjected to the image processing. Then, the image resize unit 162A enlarges the image size of the read image data (the area Ar) to the same image size as the image W700 by using the center CT of expansion as a center, and generates resize process image data (an image W701 ((b) in FIG. 26)).

In the above described sixth embodiment, advantageous effects as described below are obtained in addition to the same advantageous effects as those of the above described first embodiment.

In the sixth embodiment, the image processing setting unit 302 sets the center CT of expansion through the user touch operation. Therefore, it becomes possible to set the center CT of expansion at a position desired by the user other than the optical center CO, so that it becomes possible to generate a user's desired image that may not be obtained by the zoom blur photography using the optical center CO as a center.

Furthermore, in the sixth embodiment, the display controller 304 displays the live view image W6 on the display unit 21 to enable the user to perform touch operation. Therefore, the user is able to easily set a desired position as the center CT of expansion by performing the touch operation while viewing the live view image W6. Therefore, it becomes possible to realize the imaging apparatus 1 that is easier to use.

### Seventh Embodiment

Next, a seventh embodiment of the present invention will be explained.

In the explanation below, the same configurations and steps as those of the above described first embodiment are denoted by the same symbols, and detailed explanation thereof will be omitted or simplified.

In the above described first embodiment, in the resize process (Steps S114F and S111E), the resize ratio (enlargement ratio) is a predetermined enlargement ratio.

In contrast, in the seventh embodiment, in the various conditions setting process, the resize ratio can be set through the user touch operation. Furthermore, in the zoom blur photography according to the seventh embodiment, the zoom operation is performed based on the resize ratio set through the user touch operation.

The configuration of the imaging apparatus according to the seventh embodiment is the same as the configuration of the above described first embodiment.

In the following, only the various conditions setting process (Step S104 in FIG. 3) and the zoom blur photography (Steps S113B to S113 in FIG. 5) according to the seventh embodiment will be explained.

### Various Condition Setting Process

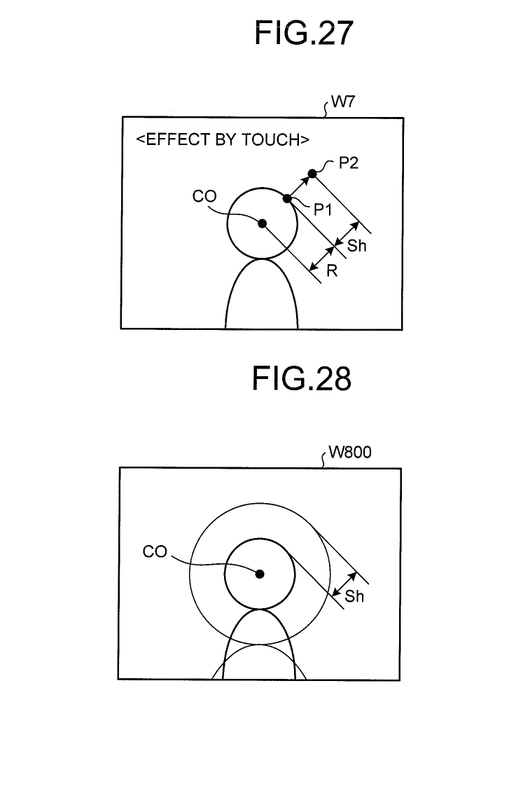

FIG. 27 is a diagram illustrating a part of screen transition of the menu screen displayed on the display unit 21 when the menu switch 205 according to the seventh embodiment is operated.

When the zoom blur photography (simulation) icon A46 is selected through the user touch operation while the special effect process selection screen W4 is being displayed on the display unit 21 ((d) in FIG. 4), the display controller 304 according to the seventh embodiment displays a live view image W7 on the display unit 21 as illustrated in FIG. 27.

The live view image W7 is a screen for causing the user to set the resize ratio by touch operation, and letters “effect by touch” are displayed in a superimposed manner.

Then, when a touch start position P1 (an outline of a subject) illustrated in FIG. 27 is touched and then sliding is performed to a touch end position P2 by the user touch operation while the live view image W7 is being displayed on the display unit 21 for example, the image processing setting unit 302 according to the seventh embodiment sets the resize ratio for the resize process (Steps S114F and S111E) as described below.

The image processing setting unit 302 calculates, as illustrated in FIG. 27, (R+Sh)/R as a zoom magnification, where R is the length from the optical center CO to the touch start position P1 and Sh is the amount of sliding (the length from the touch start position P1 to the touch end position P2).

Then, when the resize process and the composition process are repeatedly performed in the special image processing step (Steps S114E and S111D), the image processing setting unit 302 calculates the resize ratio (the enlargement ratio for the first resize process) based on the zoom magnification and the setting value (the number of compositions) such that the most enlarged image is enraged by the zoom magnification with respect to a non-enlarged original image.

Information on the zoom magnification and the resize ratio calculated by the image processing setting unit 302 is output to the SDRAM 26 via the bus 29.

As described above, the image processing setting unit 302 according to the seventh embodiment has a function as a resize ratio setting unit according to the present invention.

FIG. 28 is a diagram illustrating an image generated in the special image processing step (Step S114E in FIG. 6 and Step S111D in FIG. 10) according to the seventh embodiment.

In FIG. 28, only a non-enlarged original image and the most enlarged image are illustrated among multiple images composited through the composition process.

Then, at Steps S114F and S111E, the image processing controller 303 according to the seventh embodiment reads out information on the resize ratio from the SDRAM 26 via the bus 29 and causes the image resize unit 162A to perform the resize process (enlargement process) at the read resize ratio.

Through the above described resize process, the image corresponding to the composition process image data generated in the special image processing step becomes, as illustrated in FIG. 28, an enlarged image W800, in which the outline of a subject in the most enlarged image is located at the position separated by the sliding amount Sh from the outline of the subject in the non-enlarged original image.

### Zoom Blur Photography

The zoom blur photography controller 301 according to the seventh embodiment performs zoom operation as described below at Steps S113C and S113G.

Specifically, the zoom blur photography controller 301 reads out information on the zoom magnification from the SDRAM 26 via the bus 29.

Furthermore, the zoom blur photography controller 301 calculates the amount of movement of the zoom lens 311 corresponding to the zoom magnification, and calculates the moving speed of the zoom lens 311 based on the amount of movement and the exposure time determined by the AE processing unit 17 through the AE process (Step S116).

Then, the zoom blur photography controller 301 outputs, at Steps S113C and S113G, an instruction signal to the lens controller 42 via the main-body communication unit 28 and the lens communication unit 41, and moves the zoom lens 311 by the calculated amount of movement at the calculated moving speed.

In the above described seventh embodiment, the advantageous effects as described below are obtained in addition to the same advantageous effects as those of the above described first embodiment.

In the seventh embodiment, the image processing setting unit 302 sets the zoom magnification and the resize ratio based on the sliding amount through the user touch operation. Furthermore, when performing the zoom blur photography (Steps S113B to S113H), the zoom blur photography controller 301 performs the zoom operation based on the moving speed and the amount of movement depending on the zoom magnification. Therefore, it becomes possible to approximately equalize the zoom effect applied to the captured image by the zoom blur photography and the zoom effect simulated by the special image process. Therefore, the user can estimate a result of shooting with the zoom blur photography, by confirming an image subjected to the special image process without actually performing the zoom blur photography.

Moreover, in the seventh embodiment, the display controller 304 displays the live view image W7 on the display unit 21 to enable the user to perform touch operation. Therefore, the user can set a desired zoom magnification by performing the touch operation while viewing the live view image W7. Consequently, it becomes possible to realize the imaging apparatus 1 that is easier to use.

### Modified Example of Seventh Embodiment

In the above described seventh embodiment, in the special image processing step (Steps S114E and S111D), the setting value (the number of compositions) is a predetermined number; however, this is not the limitation.

For example, the image processing setting unit 302 may change the setting value (the number of compositions) in accordance with the number of touch operations performed by a user within a predetermined time (in the example in FIG. 27, the number of slidings repeatedly performed after the sliding from the touch start position P1 to the touch end position P2 is completed) while the live view image W7 is being displayed on the display unit 21.

In this case, the image processing setting unit 302 changes the setting value (the number of compositions) to a greater value as the number of touch operations increases.

Furthermore, for example, the touch panel 23 may be configured as a touch intensity responsive touch panel that detects the area of contact or a pressing force on the touch screen in the touch operation. Then, the image processing setting unit 302 may change the setting value (the number of compositions) depending on the intensity of the user touch operation while the live view image W7 is being displayed on the display unit 21.

In this case, the image processing setting unit 302 changes the setting value (the number of compositions) to a greater value as the intensity of the touch operation increases.

Furthermore, for example, the touch panel 23 may be configured as a touch panel capable of detecting a distance from the touch screen to a tip of a finger of the user in the touch operation. Then, the image processing setting unit 302 may change the setting value (the number of compositions) depending on the distance from the touch screen to the tip of the finger of the user in the user touch operation while the live view image W7 is being displayed on the display unit 21.

In this case, the image processing setting unit 302 changes the setting value (the number of compositions) to a greater value as the distance increases.

As described above, the image processing setting unit 302 according to the modified example of the seventh embodiment has a function as a number setting unit according to the present invention.

According to the modified example of the above described seventh embodiment, the setting value (the number of compositions) is changed depending on the number of touch operations, the intensity of the touch operation, and the distance from the touch screen and the tip of a finger of the user. Therefore, it becomes possible to generate an image with a different zoom effect as desired by the user.

### Other Embodiments

While the embodiments of the present invention have been explained above, the present invention is not limited to the above described first to seventh embodiments.

For example, the main body 2 or 2A and the lens unit 3 may be formed in an integrated manner.

Furthermore, the imaging apparatus 1 according to these embodiments is applicable to, apart from a digital single lens reflex camera, a digital camera on which an accessory or the like is mountable, a digital video camera, or an electronic device such as a mobile phone or a tablet type mobile device having an imaging function.

Moreover, the process flows are not limited to the sequences of the processes in the flowcharts described in the above described first to seventh embodiments, but may be modified as long as there is no contradiction.

Furthermore, algorithms of the processes in the flowcharts described in the present specification may be written as programs. Such programs may be recorded in a recording unit inside a computer or may be recorded in a computer readable recording medium. The programs may be recorded in the recording unit or the recording medium when the computer or the recording medium is shipped as a product or may be downloaded via a communication network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a special image processing unit that includes:
an image resize unit that performs a resize process of resizing an image size of at least a partial area of an image area of image data by using one position in at least the partial area as a center; and
an image composition unit that performs a composition process of compositing the image data and image data obtained through the resize process such that the respective one positions coincide with each other.

2. The image processing apparatus according to claim 1, wherein
the special image processing unit performs an iterative process of repeating the resize process and the composition process a predetermined number of times, and
in the iterative process, the special image processing unit re-performs the resize process on image data obtained through a previous composition process, and performs the composition process of compositing the image data and image data obtained through the re-performed resize process such that the respective one positions coincide with each other.

3. The image processing apparatus according to claim 1, wherein
the special image processing unit performs an iterative process of repeating the resize process and the composition process a predetermined number of times, and
in the iterative process, the special image processing unit re-performs the resize process on the image data by changing a resize ratio, and composites image data obtained through a previous composition process and image data obtained through the re-performed resize process such that the respective one positions coincide with each other.

4. The image processing apparatus according to claim 1, wherein the resize process is a process of enlarging the image size.

5. The image processing apparatus according to claim 4, wherein the resize process is a process of enlarging the image size of the partial area of the image area of the image data to a same size as the image data by using the one position as a center.

6. The image processing apparatus according to claim 1, wherein the resize process is a process of reducing the image size.

7. The image processing apparatus according to claim 6, wherein a composition ratio of the image data that is obtained through the resize process and that is to be composited with the image data in the composition process is set so as to be reduced as a distance from a center position of the image area of the image data obtained through the resize process increases.

8. The image processing apparatus according to claim 1, wherein the one position is a position other than a center of the image area of the image data.

9. The image processing apparatus according to claim 1, further comprising an imaging unit that captures a subject and generates image data of the subject.

10. The image processing apparatus according to claim 9, wherein the one position is a position other than an optical axis used for capturing the subject.

11. The image processing apparatus according to claim 9, further comprising:
a zoom lens that moves to change a range to be captured;
an operation input unit that receives input of an instruction signal designating one of a zoom blur photography mode to perform zoom blur photography and a simulation mode to simulate the zoom blur photography without moving the zoom lens;
a zoom blur photography controller that performs the zoom blur photography by controlling operation of the imaging unit and the zoom lens in accordance with the instruction signal designating the zoom blur photography mode input by the operation input unit; and
an image processing controller that causes the image resize unit and the image composition unit to operate in accordance with the instruction signal designating the simulation mode input by the operation input unit.

12. The image processing apparatus according to claim 11, further comprising an exposure time calculation unit that calculates an exposure time of the imaging unit based on information contained in the image data, wherein
the image processing controller causes the image resize unit and the image composition unit to operate when the exposure time calculated by the exposure time calculation unit is less than a predetermined threshold while the zoom blur photography mode is designated.

13. The image processing apparatus according to claim 9, further comprising:
an exposure time calculation unit that calculates an exposure time of the imaging unit based on information contained in the image data; and
a resize ratio setting unit that sets a resize ratio for the resize process performed by the image resize unit in accordance with the exposure time calculated by the exposure time calculation unit.

14. The image processing apparatus according to claim 9, further comprising an image reduction unit that reduces an image size of the image data generated by the imaging unit by using the one position as a center, wherein
the image resize unit performs the resize process to further reduce an image size of the image data reduced by the image reduction unit, by using the one position as a center.

15. The image processing apparatus according to claim 9, further comprising:
a display unit that displays an image corresponding to the image data generated by the imaging unit;
a touch panel that is arranged on a display screen of the display unit, that detects touch of an external object, and that outputs a signal corresponding to the detected touch; and
a center position setting unit that sets the one position for the resize process performed by the image resize unit in accordance with the signal from the touch panel.

16. The image processing apparatus according to claim 9, further comprising:
a zoom lens that moves to change a range to be captured;
an operation input unit that receives input of an instruction signal designating one of a zoom blur photography mode to perform zoom blur photography and a simulation mode to simulate the zoom blur photography without moving the zoom lens;
a zoom blur photography controller that performs the zoom blur photography by controlling operation of the imaging unit and the zoom lens in accordance with the instruction signal designating the zoom blur photography mode input by the operation input unit;
an image processing controller that causes the image resize unit and the image composition unit to operate in accordance with the instruction signal designating the simulation mode input by the operation input unit;
a display unit that displays an image corresponding to the image data generated by the imaging unit; and
a touch panel that is arranged on a display screen of the display unit, that detects touch of an external object, and that outputs a signal corresponding to the detected touch, wherein
the zoom blur photography controller controls operation of the zoom lens in accordance with the signal from the touch panel.

17. The image processing apparatus according to claim 9, further comprising:
a display unit that displays an image corresponding to the image data generated by the imaging unit;
a touch panel that is arranged on a display screen of the display unit, that detects touch of an external object, and that outputs a signal corresponding to the detected touch; and
a resize ratio setting unit that sets a resize ratio for the resize process performed by the image resize unit in accordance with the signal from the touch panel.

18. The image processing apparatus according to claim 9, further comprising:
a display unit that displays an image; and
a display controller that controls operation of the display unit, wherein
the display controller displays, on the display unit, an image corresponding to the image data generated by the imaging unit and an image corresponding to the image data obtained through the composition process performed by the image composition unit.

19. An image processing method executed by an image processing apparatus, the image processing method comprising:
resizing an image size of at least a partial area of an image area of image data by using one position in at least the partial area as a center; and
compositing the image data and image data obtained at the resizing such that the respective one positions coincide with each other.

20. The image processing method according to claim 19, further comprising repeating the resizing and the compositing a predetermined number of times, wherein
in the repeating, the resizing is re-performed on image data obtained through a previous compositing, and the image data and image data obtained through the re-performed resizing are composited by the compositing such that the respective one positions coincide with each other.

21. The image processing method according to claim 19, further comprising repeating the resizing and the compositing a predetermined number of times, wherein
in the repeating, the resizing is re-performed on the image data by changing a resize ratio, and image data obtained through a previous compositing and image data obtained through the re-performed resizing are composited by the compositing such that the respective one positions coincide with each other.

22. The image processing method according to claim 19, wherein
in the resizing, the image size is enlarged.

23. An image processing method according to claim 19, wherein
in the resizing, the image size is reduced.

24. The image processing method according to claim 19, wherein the one position is a position other than a center of the image area of the image data.

25. A non-transitory computer readable recording medium with an executable program stored thereon, wherein the program instructs a processor provided in an image processing apparatus to execute:
resizing an image size of at least a partial area of an image area of image data by using on position in at least the partial area as a center; and
compositing the image data and image data obtained at the resizing such that the respective one positions coincide with each other.

26. The non-transitory computer readable recording medium according to claim 25, wherein the program instructs the processor to further execute repeating the resizing and the compositing a predetermined number of times, wherein
in the repeating, the resizing is re-performed on image data obtained through a previous compositing, and the image data and image data obtained through the re-performed resizing are composited by the compositing such that the respective one positions coincide with each other.

27. The non-transitory computer readable recording medium according to claim 25, wherein the program instructs the processor to further execute repeating the resizing and the compositing a predetermined number of times, wherein
in the repeating, the resizing is re-performed on the image data by changing a resize ratio, and image data obtained through a previous compositing and image data obtained through the re-performed resizing are composited by the compositing such that the respective one positions coincide with each other.

28. The non-transitory computer readable recording medium according to claim 25, wherein
in the resizing, the image size is enlarged.

29. The non-transitory computer readable recording medium according to claim 25, wherein
in the resizing, the image size is reduced.

30. The non-transitory computer readable recording medium according to claim 25, wherein the one position is a position other than a center of the image area of the image data.
